(19) United States
(12) Patent Application Publication
(10) Pub. No.: US 2025/0182086 A1
(43) Pub. Date: Jun. 5, 2025

(54) SYSTEMS AND METHODS FOR PROVISIONING ESCROW AND SECURING PURCHASES

(71) Applicant: Capital One Services, LLC, McLean, VA (US)

(72) Inventors: Jeffrey Rule, Chevy Chase, MD (US); Jeffrey Carlyle Wieker, Falls Church, VA (US); Megan M. Lowe, Henrico, VA (US)

(73) Assignee: Capital One Services, LLC, McLean, VA (US)

(21) Appl. No.: 18/524,093

(22) Filed: Nov. 30, 2023

(51) Int. Cl. G06Q 20/32; G06Q 20/34; G06Q 20/40

(52) U.S. Cl. CPC G06Q 20/3224; G06Q 20/352; G06Q 20/4014

(57) ABSTRACT

Systems and methods for provisioning escrow and securing purchases can include receiving first encrypted data from a first contactless card of a seller, decrypting the first encrypted data to authenticate the first contactless card, identifying information of the seller, and responsive thereto, offering an item for sale at a purchase price via an online platform. To purchase the item for sale, second encrypted data can be received from a second contactless card of a buyer two times. First, the second encrypted data can be decrypted to authenticate the second contactless card, information of the buyer can be identified, and responsive thereto, an amount of money equal to the purchase price can be retrieved from the buyer and placed in an escrow account. Second, the second encrypted data can be decrypted to authenticate the second contactless card, and the money in the escrow account can be released to the seller.

### BACKGROUND

Websites with classified advertisements or posts for selling items, such as Craigslist and Facebook, have trust issues. For example, a seller can never be sure that a buyer will pay or won't try to renegotiate a price while picking up an item. Similarly, because the seller is often anonymous, the buyer can never be sure that the seller actually owns the item being sold.

In view of the above, there is a need for improved systems and methods for selling and purchasing items.

### BRIEF SUMMARY

In some embodiments, a method can include receiving, via a short-range communication antenna of a first mobile device, first encrypted data from a first contactless card of a seller of an item for sale via a website or a mobile application and successfully decrypting the first encrypted data to authenticate the first contactless card. When the first contactless card has been authenticated, the method can include identifying personally identifiable information of the seller and a bank or credit account number for the seller and, responsive thereto, offering the item for sale at a purchase price via the website or the mobile application. The method can also include receiving, via a short-range communication antenna of a second mobile device, second encrypted data from a second contactless card of a buyer of the item for sale and successfully decrypting the second encrypted data to authenticate the second contactless card. When the second contactless card has been authenticated, the method can include identifying personally identifiable information of the buyer and a bank or credit account number for the buyer and responsive thereto, retrieving an amount of money equal to the purchase price from a bank or credit account matching the bank or credit account number for the buyer and placing the money in an escrow account. The method can also include receiving, via the short-range communication antenna of the first mobile device or the short-range communication antenna of the second mobile device, the second encrypted data from the second contactless card a second time and successfully decrypting the second encrypted data to authenticate the second contactless card a second time. When the second contactless card has been authenticated the second time, the method can include releasing the money in the escrow account to a bank or credit account matching the bank or credit account number for the seller.

In some embodiments, the method can include identifying a location of the seller and identifying a location of the buyer.

In some embodiments, the method can include using an address for the seller to identify the location of the seller and using an address for the buyer to identify the location of the buyer, wherein the personally identifiable information of the seller includes the address for the seller, and wherein the personally identifiable information of the buyer includes the address for the buyer.

In some embodiments, the method can include using a cellular or GPS location of the first mobile device to identify the location of the seller and using a cellular or GPS location of the second mobile device to identify the location of the buyer.

In some embodiments, the method can include identifying a distance between the location of the buyer and the location of the seller and rejecting the sale from the seller to the buyer when the distance is greater than a predetermined threshold.

In some embodiments, the method can include identifying a recommended exchange location in between the location of the buyer and the location of the seller.

In some embodiments, the method can include identifying an exchange time for the buyer and seller to meet and rejecting the sale from the seller to the buyer when the location of the seller or the location of the buyer are more than a predetermined distance away from the recommended exchange location at the exchange time or within a predetermined period of time thereafter.

In some embodiments, the method can include rejecting the sale from the seller to the buyer when the location of the seller or the location of the buyer is within a predetermined high crime area.

In some embodiments, the method can include rejecting the sale from the seller to the buyer when the bank or credit account matching the bank or credit account number for the seller or the bank or credit account matching the bank or credit account number for the buyer has been a party to prior fraudulent activity.

In some embodiments, the method can include causing a notification message to be sent to the first mobile device when the money in the escrow account is sent to the bank or credit account matching the bank or credit account number for the seller.

In some embodiments, the method can include receiving the personally identifiable information of the seller or the bank or credit account number for the seller from the first contactless card and receiving the personally identifiable information of the buyer and the bank or credit account number for the buyer from the second contactless card.

In some embodiments, the method can include using the first encrypted data to retrieve the personally identifiable information of the seller or the bank or credit account number for the seller from a banking or credit authorization system and using the second encrypted data to retrieve the personally identifiable information of the buyer or the bank or credit account number for the buyer from the banking or credit authorization system.

In some embodiments, the method can include identifying a first customer account associated with the first contactless card to authenticate the first contactless card, decrypting first protected data in the first encrypted data, comparing the first protected data to first stored record data associated with the first customer account, authenticating the first contactless card based on a match between the first protected data and the first stored record data, identifying a second customer account associated with the second contactless card to authenticate the second contactless card, decrypting second protected data in the second encrypted data, comparing the second protected data to second stored record data associated with the second customer account, and authenticating the second contactless card based on a match between the second protected data and the second stored record data.

In some embodiments, a method can include receiving, via a short-range communication antenna of a mobile device, first encrypted data from a first contactless card of a seller of an item for sale via a website or a mobile application, successfully decrypting the first encrypted data to authenticate the first contactless card, and when the first contactless card has been authenticated, identifying personally identifiable information of the seller and a bank or credit account number for the seller and, responsive thereto, offering the item for sale at a purchase price via the website or the mobile application.

In some embodiments, responsive to authenticating second encrypted data from a second contactless card of a buyer of the item for sale, the method can include releasing money in an escrow account to a bank or credit account matching the bank or credit account number for the seller.

In some embodiments, responsive to authenticating the second encrypted data a first time to provision an amount of money equal to the purchase price in the escrow account and a second time to secure the item for sale, the method can include releasing the money in the escrow account to the bank or credit account matching the bank or credit account number for the seller.

In some embodiments, responsive to identifying the personally identifiable information of the seller and the bank or credit account number for the seller, the method can include creating or identifying an account for the seller on the website or the mobile application.

In some embodiments, a method can include receiving, via a short-range communication antenna of a first mobile device, encrypted data from a contactless card of a buyer of an item for sale at a purchase price via a website or a mobile application, successfully decrypting the encrypted data to authenticate the contactless card, and when the contactless card has been authenticated, identifying personally identifiable information of the buyer and a bank or credit account number for the buyer, and responsive thereto, retrieving an amount of money equal to the purchase price from a bank or credit account matching the bank or credit account number for the buyer and placing the money in an escrow account.

In some embodiments, the method can include receiving, via the short-range communication antenna of the first mobile device or a short-range communication antenna of a second mobile device, the encrypted data from the contactless card, successfully decrypting the encrypted data to authenticate the contactless card a second time, and when the contactless card has been authenticated the second time, releasing the money in the escrow account to a bank or credit account matching a bank or credit account number for a seller of the item for sale.

In some embodiments, responsive to identifying the personally identifiable information of the buyer and the bank or credit account number for the buyer, the method can include creating or identifying an account for the buyer on the website or the mobile application.

Other technical features may be readily apparent to one skilled in the art from the following figures, descriptions, and claims.

### BRIEF DESCRIPTION OF THE SEVERAL VIEWS OF THE DRAWINGS

FIG. 1 illustrates an example of a system in accordance with one embodiment.

FIG. 2 illustrates an example of a system in accordance with one embodiment.

FIG. 3 illustrates an example of a contactless card in accordance with one embodiment.

FIG. 4 illustrates an example of a transaction card component in accordance with one embodiment.

FIG. 5 illustrates an example of a sequence flow in accordance with one embodiment.

FIG. 6 illustrates an example of a data structure in accordance with one embodiment.

FIG. 7 illustrates an example of a key system in accordance with one embodiment.

FIG. 8 illustrates an example of a method of generating a cryptogram in accordance with one embodiment.

FIG. 9 illustrates an example of a method of key diversification in accordance with one embodiment.

FIG. 10 illustrates an example of a method of card activation in accordance with one embodiment.

FIG. 11 illustrates an example of a mobile device in accordance with one embodiment.

FIG. 12 illustrates an example of a server device in accordance with one embodiment.

FIG. 13 illustrates an example of a system in accordance with one embodiment.

FIG. 14A illustrates an example of a method of securing an offer for sale in accordance with one embodiment.

FIG. 14B illustrates an example of a method of securing an offer for purchase in accordance with one embodiment.

FIG. 14C illustrates an example of a method of securing a purchase in accordance with one embodiment.

FIG. 15 illustrates an example of a computer architecture in accordance with one embodiment.

FIG. 16 illustrates an example of a communications architecture in accordance with one embodiment.

FIG. 17 illustrates an example of a sequence flow in accordance with one embodiment.

### DETAILED DESCRIPTION

Embodiments disclosed herein are generally directed to systems and methods for provisioning escrow and securing purchases. For example, systems and methods disclosed herein can ensure that a seller of an item for sale is doubly trusted prior to authorizing the seller to offer the item for sale via a website or a mobile application. Similarly, systems and methods disclosed herein can ensure that a buyer of the item for sale is doubly trusted prior to both authorizing the buyer to purchase the item for sale and releasing money for a purchase price of the item for sale from the buyer to the seller.

In this regard and on the seller side, systems and methods disclosed herein can receive first encrypted data from a first contactless card of the seller and decrypt the first encrypted data to authenticate the first contactless card. As described herein, contactless cards can include any transaction card that can be used to purchase goods or services and/or withdraw or transfer money from an account. When the first contactless card has been authenticated, systems and methods disclosed herein can ensure that the seller is doubly trusted by identifying both personally identifiable information of the seller and a bank or credit account number for the seller and, responsive thereto, offer the item for sale at a purchase price via the website or the mobile application. The first encrypted data can be received via a short-range communication antenna of a first mobile device of the seller. As such, with a single tap of the first contactless card on the first mobile device to bring the first contactless card within a communication range of the short-range communication antenna of the first mobile device, systems and methods disclosed herein can validate both an identity of the seller and banking information for the seller, set up or access an account for the seller with the website or the mobile application to sell the item for sale, and establish a bank or credit account for receiving an amount of money equal to the purchase price from the buyer upon completion of the sale.

On the buyer side, systems and methods disclosed herein can receive second encrypted data from a second contactless card of the buyer and decrypt the second encrypted data to authenticate the second contactless card. When the second contactless card has been authenticated, systems and methods disclosed herein can ensure that the buyer is doubly trusted by identifying both personally identifiable information of the buyer and a bank or credit account number for the buyer and, responsive thereto, retrieve an amount of money equal to the purchase price from a bank or credit account matching the bank or credit account number for the buyer and place the money in an escrow account. As such, with a single tap of the second contactless card on a second mobile device of the buyer to bring the second contactless card within a communication range of the short-range communication antenna of the second mobile device, systems and methods disclosed herein can validate both an identity of the buyer and banking information for the buyer, set up or access an account for the buyer with the website or the mobile application to purchase the item for sale, and authorize a transfer of the amount of money equal to the purchase price to the escrow account.

The money from the buyer can be held in the escrow account until the buyer examines the item for sale and/or the seller transfers possession of the item for sale to the buyer. In this regard, to confirm that the buyer is in possession of the item for sale, systems and methods disclosed herein can receive the second encrypted data from the second contactless card a second time and decrypt the second encrypted data to authenticate the second contactless card a second time. When the second contactless card has been authenticated the second time, systems and methods disclosed herein can release the money in the escrow account to the bank or credit account matching the bank or credit account number for the seller, and in some embodiments, cause a notification message indicative thereof to be sent to the first mobile device of the seller. As such, with a single tap of the second contactless card on the second mobile device to bring the second contactless card within a communication range of the short-range communication antenna of the second mobile device, systems and methods disclosed herein can validate both the identity of the buyer and the banking information for the buyer and authorize a transfer of the money in the escrow account to the bank or credit account matching the bank or credit account for the seller.

Trust is of utmost importance in embodiments disclosed herein. As such, systems and methods disclosed herein can ensure that the seller is trusted prior to offering the item for sale via the website or the mobile application. Similarly, systems and methods disclosed herein can ensure that the buyer is trusted prior to offering to purchase the item for sale via the website or the mobile application. In this regard, systems and methods disclosed herein can receive the personally identifiable information of the seller or the bank or credit account number for the seller from the first contactless card and can receive the personally identifiable information of the buyer and the bank or credit account number for the buyer from the second contactless card. Additionally or alternatively, systems and methods disclosed herein can use the first encrypted data to retrieve the personally identifiable information of the seller or the bank or credit account number for the seller from a banking or credit authorization system and can use the second encrypted data to retrieve the personally identifiable information of the buyer or the bank or credit account number for the buyer from the banking or credit authorization system.

Even further, systems and methods disclosed herein can ensure that the seller possesses and the buyer receives the item for sale prior to transferring any funds from the buyer to the seller via the escrow account. Advantageously, the seller can be sure that the funds are available in the escrow account prior to releasing the item to the buyer, and the buyer can be sure that the item is satisfactory prior to releasing the funds to the seller.

It is to be understood that systems and methods disclosed herein can be implemented when the item for sale must be picked up in person. In these embodiments, systems and methods disclosed herein can identify a location of the seller, for example, using an address for the seller included in the personally identifiable information of the seller and/or using a cellular or GPS location of the first mobile device of the seller, and can identify a location of the buyer, for example, using an address for the buyer included in the personally identifiable information of the buyer and/or using a cellular or GPS location of the second mobile device of the buyer. In some of these embodiments, when a distance between the location of the buyer and the location of the seller is greater than a predetermined threshold, systems and methods disclosed herein can reject the sale from the seller to the buyer. Additionally or alternatively, in some of these embodiments, systems and methods disclosed herein can identify a recommended exchange location in between the location of the buyer and the location of the seller, for example, a public place, such as a police station, a fire station, a library, and the like, and/or an exchange time for the buyer and the seller to meet. When the location of the seller or the location of the buyer are more than a predetermined distance away from the recommended exchange location at the exchange time or within a predetermined period of time thereafter, systems and methods disclosed herein can reject the sale from the seller to the buyer. Additionally or alternatively, systems and methods disclosed herein can reject the sale from the seller to the buyer when the location of the seller or the location of the buyer is within a predetermined high crime area and/or when the bank or credit account matching the bank or credit account number for the seller or the bank or credit account matching the bank or credit account number for the buyer has been a party to prior fraudulent activity.

However, it is also to be understood that systems and methods disclosed herein can be implemented when the item for sale can be transferred digitally, such as concert tickets, cryptocurrency, and the like. In these embodiments, the item for sale can be placed in the escrow account as part of the seller offering the item for sale via the website or the mobile application. As such, systems and methods disclosed herein, third party applications in communication therewith, and/or the buyer can confirm authenticity of the item for sale in the escrow account prior to receiving and decrypting the second encrypted data from the second contactless card of the buyer the second time. Then, systems and methods disclosed herein can simultaneously release the item for sale in the escrow account to the buyer and release the money in the escrow account to the bank or credit account matching the bank or credit account number for the seller.

Details of the above-identified embodiments and additional advantages thereof are discussed in the following description.

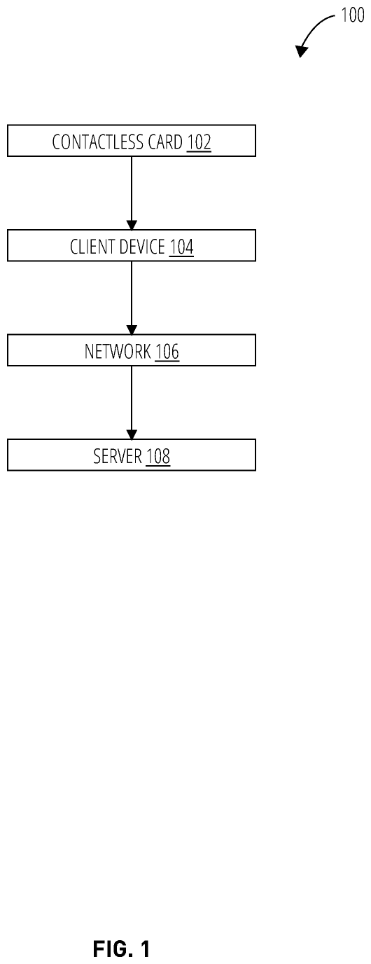

FIG. 1 illustrates a data transmission system 100 according to an example embodiment. As further discussed below, the system 100 may include a contactless card 102, a client device 104, a network 106, and a server 108. Although FIG. 1 illustrates single instances of the components, the system 100 may include any number of components.

The system 100 may include one or more contactless cards 102, which are further explained below. In some embodiments, the contactless card 102 may be in wireless communication, utilizing Near-Field Communication (NFC) in an example, with the client device 104.

The system 100 may include the client device 104, which may be a network-enabled computer. As referred to herein, a network-enabled computer may include, but is not limited to a computer device, or a communications device including, e.g., a server, a network appliance, a personal computer, a workstation, a phone, a handheld personal computer (PC), a personal digital assistant, a thin client, a fat client, an Internet browser, or other device. The client device 104 also may be a mobile device; for example, a mobile device may include an iPhone, iPod, iPad from Apple® or any other mobile device running Apple's iOS® operating system, any device running Microsoft's Windows® mobile operating system, any device running Google's Android® operating system, and/or any other smartphone, tablet, or like wearable mobile device.

The client device 104 device can include a processor and a memory, and it is understood that the processing circuitry may contain additional components, including processors, memories, error and parity/cyclic redundance check (CRC) checkers, data encoders, anticollision algorithms, controllers, command decoders, security primitives and tamperproofing hardware, as necessary to perform the functions described herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into a user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, the client device 104 of the system 100 may execute one or more applications, such as software applications, that enable, for example, network communications with one or more components of the system 100 and transmit and/or receive data.

The client device 104 may be in communication with one or more server(s) 108 via one or more network(s) 106, and may operate as a respective front-end to back-end pair with the server 108. The client device 104 may transmit, for example, from a mobile device application executing on the client device 104, one or more requests to the server 108. The one or more requests may be associated with retrieving data from the server 108. The server 108 may receive the one or more requests from the client device 104. Based on the one or more requests from the client device 104, the server 108 may be configured to retrieve the requested data from one or more databases (not shown). Based on receipt of the requested data from the one or more databases, the server 108 may be configured to transmit the received data to the client device 104, the received data being responsive to the one or more requests.

The system 100 may include one or more networks 106. In some examples, the network 106 may be one or more of a wireless network, a wired network or any combination of wireless network and wired network, and may be configured to connect the client device 104 to the server 108. For example, the network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, Digital Advanced Mobile Phone System (D-AMPS), Wi-Fi, Fixed Wireless Data, Institute of Electrical and Electronics Engineers (IEEE) 802.11 family of networking, Bluetooth, NFC, Radio Frequency Identification (RFID), Wi-Fi, and/or the like.

In addition, the network 106 may include, without limitation, telephone lines, fiber optics, IEEE Ethernet 802.3, a wide area network, a wireless personal area network, a LAN, or a global network such as the Internet. In addition, the network 106 may support an Internet network, a wireless communication network, a cellular network, or the like, or any combination thereof. The network 106 may further include one network, or any number of the exemplary types of networks mentioned above, operating as a stand-alone network or in cooperation with each other. The network 106 may utilize one or more protocols of one or more network elements to which they are communicatively coupled. The network 106 may translate to or from other protocols to one or more protocols of network devices. Although the network 106 is depicted as a single network, it should be appreciated that according to one or more examples, the network 106 may comprise a plurality of interconnected networks, such as, for example, the Internet, a service provider's network, a cable television network, corporate networks, such as credit card association networks, and home networks.

The system 100 may include one or more servers 108. In some examples, the server 108 may include one or more processors, which are coupled to memory. The server 108 may be configured as a central system, server or platform to control and call various data at different times to execute a plurality of workflow actions. The server 108 may be configured to connect to the one or more databases. The server 108 may be connected to at least one client device 104.

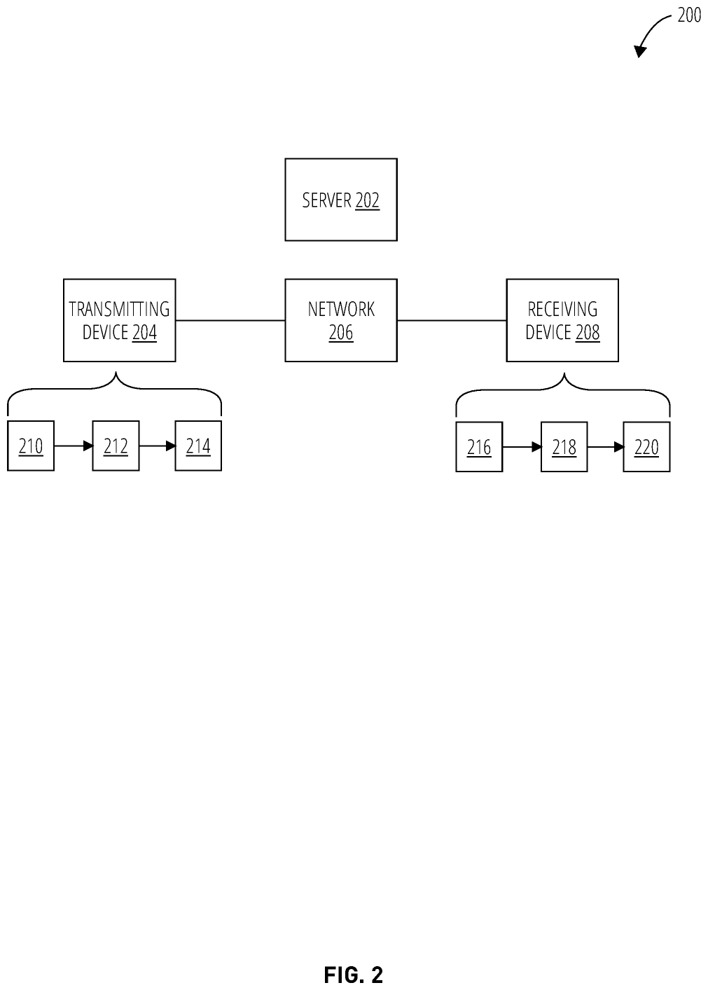

FIG. 2 illustrates a data transmission system 200 according to an example embodiment. The system 200 may include a transmitting or transmitting device 204, a receiving or receiving device 208 in communication, for example, via network 206, with one or more servers 202. The transmitting or transmitting device 204 may be the same as, or similar to, the client device 104 discussed above with reference to FIG. 1. The eceiving or receiving device 208 may be the same as, or similar to, the client device 104 discussed above with reference to FIG. 1. The network 206 may be similar to the network 106 discussed above with reference to FIG. 1. The server 202 may be similar to the server 108 discussed above with reference to FIG. 1. Although FIG. 2 shows single instances of components of the system 200, the system 200 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduces exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used without needing to resort to any form of key exchange to keep the parties in sync. By periodically changing the shared secret symmetric key used by the sender and the recipient, the attacks described above are rendered impossible.

Referring back to FIG. 2, the system 200 may be configured to implement key diversification. For example, a sender and recipient may desire to exchange data (e.g., original sensitive data) via respective devices 204 and 208. As explained above, although single instances of the transmitting device 204 and the receiving device 208 may be included, it is understood that one or more transmitting devices 204 and one or more receiving devices 208 may be involved so long as each party shares the same shared secret symmetric key. In some examples, the transmitting device 204 and the receiving device 208 may be provisioned with the same master symmetric key. Further, it is understood that any party or device holding the same secret symmetric key may perform the functions of the transmitting device 204 and similarly any party holding the same secret symmetric key may perform the functions of the receiving device 208. In some examples, the symmetric key may comprise the shared secret symmetric key which is kept secret from all parties other than the transmitting device 204 and the receiving device 208 involved in exchanging the secure data. It is further understood that both the transmitting device 204 and the receiving device 208 may be provided with the same master symmetric key, and further that part of the data exchanged between the transmitting device 204 and the receiving device 208 comprises at least a portion of data which may be referred to as the counter value. The counter value may comprise a number that changes each time data is exchanged between the transmitting device 204 and the receiving device 208.

The system 200 may include one or more networks 206. In some examples, the network 206 may be one or more of a wireless network, a wired network or any combination of wireless network and wired network, and may be configured to connect one or more transmitting devices 204 and one or more receiving devices 208 to the server 202. For example, the network 206 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, the network 206 may include, without limitation, telephone lines, fiber optics, IEEE Ethernet 902.3, a wide area network, a wireless personal area network, a LAN, or a global network such as the Internet. In addition, the network 206 may support an Internet network, a wireless communication network, a cellular network, or the like, or any combination thereof. The network 206 may further include one network, or any number of the exemplary types of networks mentioned above, operating as a stand-alone network or in cooperation with each other. The network 206 may utilize one or more protocols of one or more network elements to which they are communicatively coupled. The network 206 may translate to or from other protocols to one or more protocols of network devices. Although the network 206 is depicted as a single network, it should be appreciated that according to one or more examples, the network 206 may comprise a plurality of interconnected networks, such as, for example, the Internet, a service provider's network, a cable television network, corporate networks, such as credit card association networks, and home networks.

In some examples, one or more transmitting devices 204 and one or more receiving devices 208 may be configured to communicate and transmit and receive data between each other without passing through the network 206. For example, communication between the one or more transmitting devices 204 and the one or more receiving devices 208 may occur via at least one of NFC, Bluetooth, RFID, Wi-Fi, and/or the like.

At block 210, when the transmitting device 204 is preparing to process the sensitive data with symmetric cryptographic operation, the sender may update a counter. In addition, the transmitting device 204 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or Advanced Encryption Standard 128 (AES128); a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 212, the transmitting device 204 may take the selected cryptographic algorithm, and using the master symmetric key, process the counter value. For example, the sender may select a symmetric encryption algorithm, and use a counter which updates with every conversation between the transmitting device 204 and the receiving device 208. The transmitting device 204 may then encrypt the counter value with the selected symmetric encryption algorithm using the master symmetric key, creating a diversified symmetric key.

In some examples, the counter value may not be encrypted. In these examples, the counter value may be transmitted between the transmitting device 204 and the receiving device 208 at block 212 without encryption.

At block 214, the diversified symmetric key may be used to process the sensitive data before transmitting the result to the receiving device 208. For example, the transmitting device 204 may encrypt the sensitive data using a symmetric encryption algorithm using the diversified symmetric key, with the output comprising the protected encrypted data. The transmitting device 204 may then transmit the protected encrypted data, along with the counter value, to the receiving device 208 for processing.

At block 216, the receiving device 208 may first take the counter value and then perform the same symmetric encryption using the counter value as input to the encryption, and the master symmetric key as the key for the encryption. The output of the encryption may be the same diversified symmetric key value that was created by the sender.

At block 218, the receiving device 208 may then take the protected encrypted data and using a symmetric decryption algorithm along with the diversified symmetric key, decrypt the protected encrypted data.

At block 220, as a result of the decrypting the protected encrypted data, the original sensitive data may be revealed.

The next time sensitive data needs to be sent from the sender to the recipient via the respective transmitting device 204 and the respective receiving device 208, a different counter value may be selected producing a different diversified symmetric key. By processing the counter value with the master symmetric key and the same symmetric cryptographic algorithm, both the transmitting device 204 and the receiving device 208 may independently produce the same diversified symmetric key. This diversified symmetric key, not the master symmetric key, is used to protect the sensitive data.

As explained above, both the transmitting device 204 and the receiving device 208 each initially possess the shared master symmetric key. The shared master symmetric key is not used to encrypt the original sensitive data. Because the diversified symmetric key is independently created by both the transmitting device 204 and the receiving device 208, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 204 and the receiving device 208 may be governed by symmetric requirements for how often to create a new diversification value, and therefore a new diversified symmetric key. In an embodiment, a new diversification value and therefore a new diversified symmetric key may be created for every exchange between the transmitting device 204 and the receiving device 208.

In some examples, the key diversification value may comprise the counter value. Other non-limiting examples of the key diversification value include: a random nonce generated each time a new diversified key is needed, the random nonce sent from the transmitting device 204 to the receiving device 208; the full value of a counter value sent from the transmitting device 204 and the receiving device 208; a portion of a counter value sent from the transmitting device 204 and the receiving device 208; a counter independently maintained by the transmitting device 204 and the receiving device 208 but not sent between the two devices; a one-time-passcode exchanged between the transmitting device 204 and the receiving device 208; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 204 and the receiving device 208. In effect, this may create a one-time use key, such as a single-use session key.

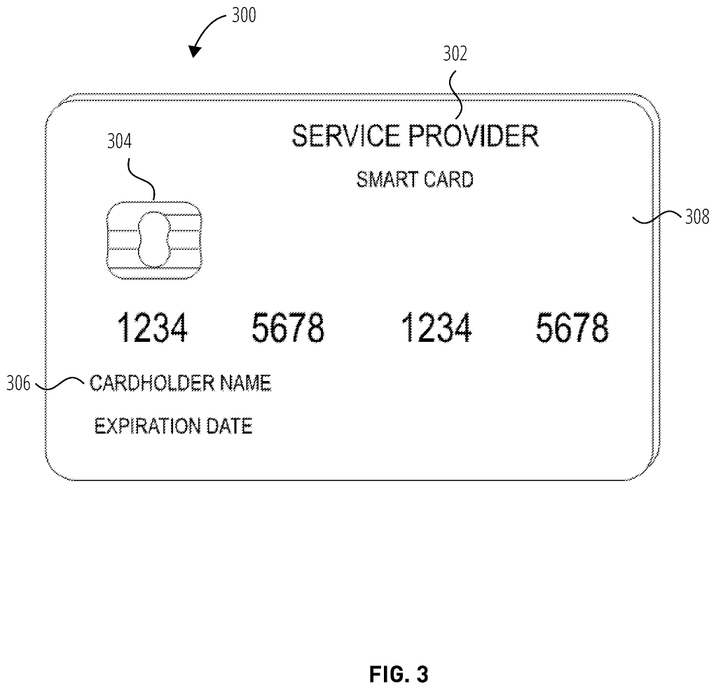

FIG. 3 illustrates an example configuration of a contactless card 300, which may include a transaction card or a payment card, such as a credit card, debit card, or gift card, issued by a service provider as displayed as service provider indicia 302 on the front or back of the contactless card 102. In some examples, the contactless card 300 is not related to a payment card, and may include, without limitation, an identification card. In some examples, the contactless card 300 may include a dual interface contactless payment card, a rewards card, and so forth. The contactless card 300 may include a substrate 308, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 300 may have physical characteristics compliant with the ID-1 format of the International Organization for Standardization (ISO)/International Electrotechnical Commission (IEC) 7816 standard, and the contactless card 300 may otherwise be compliant with the ISO/IEC 14443 standard. However, it is to be understood that the contactless card 300 according to the present disclosure may have different characteristics, and the present disclosure does not require a contactless card to be implemented in a payment card.

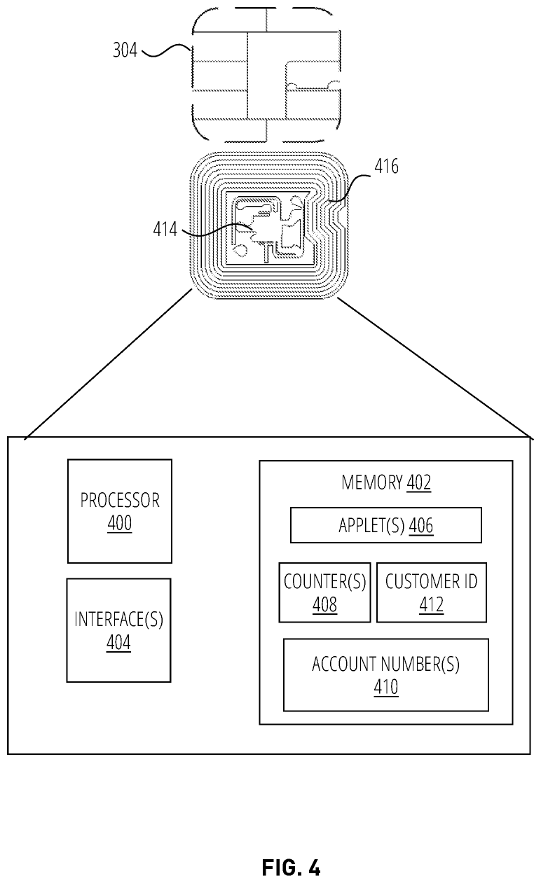

The contactless card 300 may also include identification information 306 displayed on the front and/or the back of the card, and a contact pad 304. The contact pad 304 may include one or more pads and be configured to establish contact with another client device, such as an ATM, user device, smartphone, laptop, desktop, or tablet computer via transaction cards. The contact pad 304 may be designed in accordance with one or more standards, such as ISO/IEC 7816 standard, and enable communication in accordance with the EMV protocol. The contactless card 300 may also include processing circuitry, antenna and other components as will be further discussed in FIG. 4. These components may be located behind the contact pad 304 or elsewhere on the substrate 308, e.g. within a different layer of the substrate 308, and may be electrically and physically coupled with the contact pad 304. The contactless card 300 may also include a magnetic strip or tape, which may be located on the back of the card (not shown in FIG. 3). The contactless card 300 may also include an NFC device coupled with an antenna capable of communicating via the NFC protocol. Embodiments are not limited in this manner.

As illustrated in FIG. 4, the contact pad 304 of the contactless card 300 may include processing circuitry 414 for storing, processing, and communicating information, including a processor 400, a memory 402, and one or more interface(s) 404. It is to be understood that the processing circuitry 414 may contain additional components, including processors, memories, error and parity/CRC checkers, data encoders, anticollision algorithms, controllers, command decoders, security primitives and tamperproofing hardware, as necessary to perform the functions described herein.

The memory 402 may be a read-only memory, write-once read-multiple memory or read/write memory, e.g., random-access memory (RAM), read-only memory (ROM), and electronically erasable programmable ROM (EEPROM), and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 402 may be encrypted memory utilizing an encryption algorithm executed by the processor 400 to encrypt data.

The memory 402 may be configured to store one or more applet(s) 406, one or more counter(s) 408, a customer identifier 412, and account number(s) 410, which may be virtual account numbers. The one or more applet(s) 406 may comprise one or more software applications configured to execute on one or more contactless cards, such as a Java® Card applet. However, it is understood that applet(s) 406 are not limited to Java Card applets, and instead may be any software application operable on contactless cards or other devices having limited memory. The one or more counter(s) 408 may comprise a numeric counter sufficient to store an integer. The customer identifier 412 may comprise a unique alphanumeric identifier assigned to a user of the contactless card 300, and the customer identifier 412 may distinguish the user of the contactless card 300 from other contactless card users. In some examples, the customer identifier 412 may identify both a customer and an account assigned to that customer and may further identify the contactless card 300 associated with the customer's account. As stated, the account number(s) 410 may include thousands of one-time use virtual account numbers associated with the contactless card 300. The applet(s) 406 of the contactless card 300 may be configured to manage the account number(s) 410 (e.g., to select an account number(s) 410, mark selected account number(s) 410 as used, and transmit the account number(s) 410 to a mobile device for autofilling by an autofilling service.

The processor 400 and the memory 402 of the foregoing exemplary embodiments are described with reference to the contact pad 304, but the present disclosure is not limited thereto. It is understood that these elements may be implemented outside of the contact pad 304 or entirely separate from it, or as further elements in addition to the processor 400 and the memory 402 located within the contact pad 304.

In some examples, the contactless card 300 may comprise one or more antenna(s) 416. The one or more antenna(s) 416 may be placed within the contactless card 300 and around the processing circuitry 414 of the contact pad 304. For example, the one or more antenna(s) 416 may be integral with the processing circuitry 414, and the one or more antenna(s) 416 may be used with an external booster coil. As another example, the one or more antenna(s) 416 may be external to the contact pad 304 and the processing circuitry 414.

In an embodiment, the coil of contactless card 300 may act as a secondary of an air core transformer. A terminal may communicate with the contactless card 300 by cutting power or amplitude modulation. The contactless card 300 may infer data transmitted from the terminal using gaps in the contactless card's 300 power connection, which may be function ally maintained through one or more capacitors. The contactless card 300 may communicate back by switching a load on the contactless card's 300 coil or load modulation. Load modulation may be detected in the terminal's coil through interference. More generally, using the antenna(s) 416, the processor 400, and/or the memory 402, the contactless card 300 provides a communications interface to communicate via NFC, Bluetooth, and/or Wi-Fi communications.

As explained above, the contactless card 300 may be built on a software platform operable on smart cards or other devices having limited memory, such as JavaCard, and one or more or more applications or applets may be securely executed. The applet(s) 406 may be added to contactless cards to provide a one-time password (OTP) for multifactor authentication (MFA) in various mobile application-based use cases. The applet(s) 406 may be configured to respond to one or more requests, such as near field data exchange requests, from a reader, such as a mobile NFC reader (e.g., of a mobile device or point-of-sale terminal), and produce a near field data exchange (NDEF) message that comprises a cryptographically secure OTP encoded as an NDEF text tag.

One example of an NDEF OTP is an NDEF short-record layout (SR=1). In such an example, one or more applet(s) 406 may be configured to encode the OTP as an NDEF type 4 well known type text tag. In some examples, NDEF messages may comprise one or more records. The applet(s) 406 may be configured to add one or more static tag records in addition to the OTP record.

In some examples, the one or more applet(s) 406 may be configured to emulate an RFID tag. The RFID tag may include one or more polymorphic tags. In some examples, each time the tag is read, different cryptographic data is presented that may indicate the authenticity of the contactless card 300. Based on the one or more applet(s) 406, an NFC read of the tag may be processed, data may be transmitted to a server, such as a server of a banking system, and the data may be validated at the server.

In some examples, the contactless card 300 and the server may include certain data such that the contactless card 300 may be properly identified. The contactless card 300 may include one or more unique identifiers (not pictured). Each time a read operation takes place, the counter(s) 408 may be configured to increment. In some examples, each time data from the contactless card 300 is read (e.g., by a mobile device), the counter(s) 408 is transmitted to the server for validation and to determine whether the counter(s) 408 is equal (as part of the validation) to a counter of the server.

The one or more counter(s) 408 may be configured to prevent a replay attack. For example, if a cryptogram has been obtained and replayed, that cryptogram is immediately rejected if the counter(s) 408 has been read or used or otherwise passed over. If the counter(s) 408 has not been used, it may be replayed. In some examples, the counter that is incremented on the card is different from the counter that is incremented for transactions. The contactless card 300 is unable to determine the application transaction counter(s) 408 since there is no communication between the applet(s) 406 on the contactless card 300.

In some examples, the counter(s) 408 may get out of sync. In some examples, to account for accidental reads that initiate transactions, such as reading at an angle, the counter(s) 408 may increment but the application does not process the counter(s) 408. In some examples, when a mobile device is woken up, NFC may be enabled and the mobile device may be configured to read available tags, but no action is taken responsive to the reads.

To keep the counter(s) 408 in sync, an application, such as a background application, may be executed that would be configured to detect when the mobile device wakes up and synchronizes with the server of a banking system indicating that a read that occurred due to detection to then move the counter(s) 408 forward. In other examples, Hashed One Time Password may be utilized such that a window of mis-synchronization may be accepted. For example, if within a threshold of 10, the counter(s) 408 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 408 increases in the appropriate sequence, then it possible to know that the user has done so.

The key diversification technique described herein with reference to the counter(s) 408, the master key, and the diversified key, is one example of encryption and/or decryption in a key diversification technique. This example key diversification technique should not be considered limiting of the disclosure, as the disclosure is equally applicable to other types of key diversification techniques.

During the creation process of the contactless card 300, two cryptographic keys may be assigned uniquely per card. The cryptographic keys may comprise symmetric keys which may be used in both encryption and decryption of data. A Triple Data Encryption Standard (DES) (3DES) algorithm may be used by EMV and it is implemented by hardware in the contactless card 300. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 300 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

An authentication message may be delivered as content of a text NDEF record in hexadecimal American Standard Code for Information Interchange (ASCII) format. In another example, the NDEF record may be encoded in hexadecimal format.

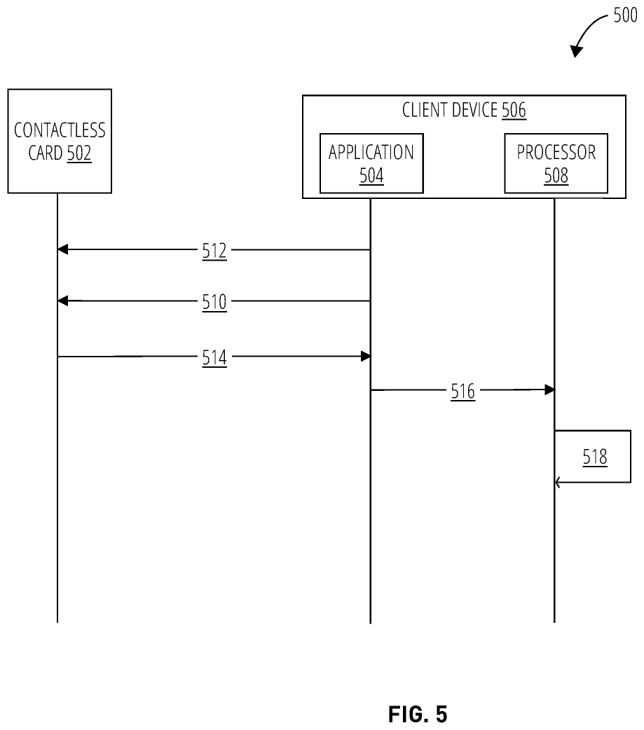

FIG. 5 is a timing diagram illustrating an example sequence for providing authenticated access according to one or more embodiments of the present disclosure. Sequence flow 500 may include a contactless card 502 and a client device 506, which may include an application 504 and a processor 508.

At line 512, the application 504 communicates with the the contactless card 502 (e.g., after being brought near the contactless card 502). Communication between the application 504 and the contactless card 502 may involve the contactless card 502 being sufficiently close to a card reader (not shown) of the client device 506 to enable NFC data transfer between the application 504 and the contactless card 502.

At line 510, after communication has been established between the client device 506 and the contactless card 502, the contactless card 502 generates encrypted data, which can include a message authentication code (MAC) cryptogram. In some examples, this may occur when the contactless card 502 is read by the application 504. In particular, this may occur upon a read, such as an NFC read, of a NDEF tag, which may be created in accordance with the NFC Data Exchange Format. For example, a reader application, such as the application 504, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 502 may be updated or incremented, which may be followed by “Read NDEF file.” At this point, the message may be generated which may include a header and a shared secret. Session keys may then be generated. A MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, the application 504 may be configured to transmit a request to the contactless card 502, the request comprising an instruction to generate a MAC cryptogram.

At line 514, the contactless card 502 sends the MAC cryptogram to the application 504. In some examples, the transmission of the MAC cryptogram occurs via NFC, however, the present disclosure is not limited thereto. In other examples, this communication may occur via Bluetooth, Wi-Fi, or other means of wireless data communication. At line 516, the application 504 communicates the MAC cryptogram to the processor 508.

At line 518, the processor 508 verifies the MAC cryptogram pursuant to an instruction from the application 504. For example, the MAC cryptogram may be verified, as explained below. In some examples, verifying the MAC cryptogram may be performed by a device other than the client device 506, such as a server of a banking system in data communication with the client device 506. For example, the processor 508 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the Rivest-Shamir-Adleman (RSA) algorithm, or zero knowledge protocols, may be used to perform this verification.

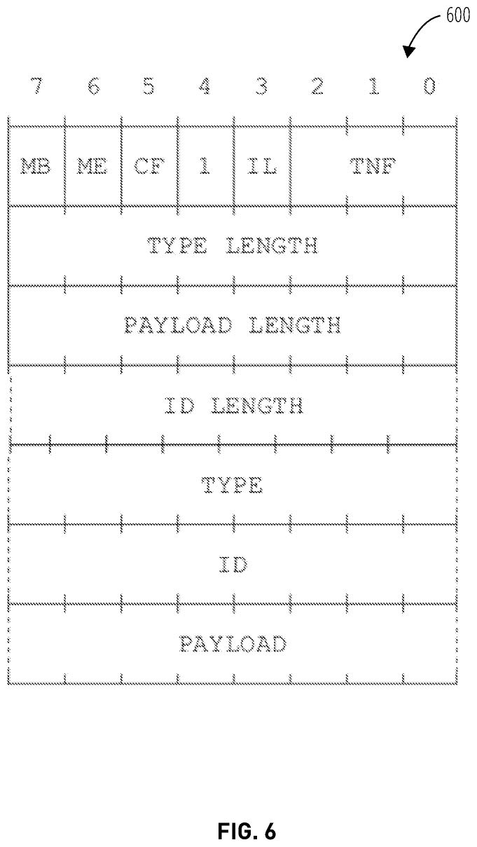

FIG. 6 illustrates an NDEF short-record layout (SR=1) data structure 600 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, an authentication template may comprise the first record, with a well-known index for providing the actual dynamic authentication data.

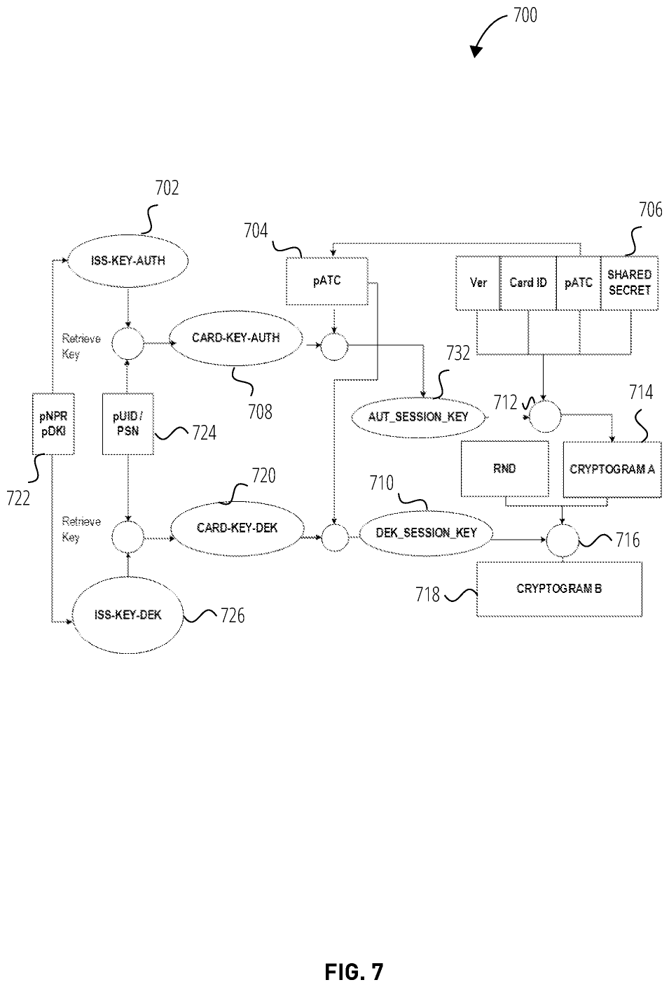

FIG. 7 illustrates a system 700 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 702, 726 may be required for each part of the portfolio on which the one or more applets is issued. For example, the first master key 702 may comprise an Issuer Cryptogram Generation/Authentication Key (Iss-Key-Auth) and the second master key 726 may comprise an Issuer Data Encryption Key (Iss-Key-DEK). As further explained herein, the two issuer master keys 702, 726 are diversified into card master keys 708, 720, which are unique for each card. In some examples, a network profile record ID (pNPR) 722 and derivation key index (pDKI) 724, as back office data, may be used to identify which issuer master keys 702, 726 to use in the cryptographic processes for authentication. The system performing the authentication may be configured to retrieve values of pNPR 722 and pDKI 724 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 708 and Card-Key-Dek 720). The session keys (Aut-Session-Key 732 and DEK-Session-Key 710) may be generated by the one or more applets and derived by using the application transaction counter (pATC) 704 with one or more algorithms. To fit data into the one or more algorithms, only the 2 low order bytes of the 4-byte pATC 704 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’∥PATC(four bytes) SK:={(ALG (MK) [F1])∥ALG (MK) [F2]}, where ALG may include 3DES Electronic Code Book (ECB) and MK may include the card unique derived master key.

As described herein, one or more MAC session keys may be derived using the lower two bytes of the pATC 704. At each tap of the contactless card, the pATC 704 is configured to be updated, and the card master keys Card-Key-AUTH 708 and Card-Key-DEK 720 are further diversified into the session keys Aut-Session-Key 732 and DEK-Session-KEY 710. The pATC 704 may be initialized to zero at personalization or applet initialization time. In some examples, the pATC 704 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

An authentication message may be delivered as the content of a text NDEF record in hexadecimal ASCII format. In some examples, only authentication data and an 8-byte random number followed by the MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 732. The data specified in the cryptogram may be processed with javacard.signature method: ALG_DES_MAC8_ISO9797_1_M2_ALG3 to correlate to EMV Authorization Request Cryptogram (ARQC) verification methods. The key used for this computation may comprise a session key AUT-Session-Key 732, as explained above. As explained above, the low order two bytes of the counter may be used to diversify for the one or more MAC session keys. As explained below, AUT-Session-Key 732 may be used to encrypt MAC data 706, and the resulting data or cryptogram A 714 and random number RND may be encrypted using DEK-Session-Key 710 to create cryptogram B or output 718 sent in the message.

In some examples, one or more Hardware Security Module (HSM) commands may be processed for decrypting such that the final 16 (binary, 32 hex) bytes may comprise a 3DES symmetric encrypting using cipher-block chain (CBC) mode with a zero IV of the random number followed by MAC authentication data. The key used for this encryption may comprise a session key DEK-Session-Key 710 derived from the Card-Key-DEK 720. In this case, an Application Transaction Value Counter (ATC) value for the session key derivation is the least significant byte of the pATC 704.

The format below represents a binary version example embodiment. Further, in some examples, the first byte may be set to ASCII ‘A’.

| Message Format | | | | |
|---|---|---|---|---|
| 1 | 2 | 4 | 8 | 8 |
| 0x43 (Message | Version | pATC | RND | Cryptogram A |
| Type ‘A’) | | | | (MAC) |
| Cryptogram A | | | | |
| (MAC) | 8 bytes | | | |
| MAC of | | | | |
| 2 | 8 | 4 | 4 | 18 bytes input data |
| Version | pUID | pATC | Shared Secret | |
| Message Format | | | | |
| 1 | 2 | 4 | | 16 |
| 0x43 (Message | Version | pATC | | Cryptogram B |
| Type ‘A’) | | | | |
| Cryptogram A | | | | |
| (MAC) | 8 bytes | | | |
| MAC of | | | | |
| 2 | 8 | 4 | 4 | 18 bytes input data |
| Version | pUID | pATC | Shared Secret | |
| Cryptogram B | 16 | | | |
| Sym Encryption | | | | |
| of | | | | |
| 8 | 8 | | | |
| RND | Cryptogram A | | | |

Another exemplary format is shown below. In this example, the tag may be encoded in hexadecimal format.

| Message Format | | | | |
|---|---|---|---|---|
| 2 | 8 | 4 | 8 | 8 |
| Version | pUID | pATC | RND | Cryptogram A |
| | | | | (MAC) |
| 8 bytes | | | | |
| 8 | 8 | 4 | 4 | 18 bytes input data |
| pUID | pUID | pATC | Shared Secret | |
| Message Format | | | | |
| 2 | 8 | 4 | | 16 |
| Version | pUID | pATC | | Cryptogram B |
| 8 bytes | | | | |
| 8 | | 4 | 4 | 18 bytes input data |
| pUID | pUID | pATC | Shared Secret | |
| Cryptogram B | 16 | | | |
| Sym Encryption | | | | |
| of | | | | |
| 8 | 8 | | | |
| RND | Cryptogram A | | | |

A Unique Identifier (UID) field of the received message may be extracted to derive, from master keys Iss-Key-AUTH 702 and Iss-Key-DEK 726, the card master keys (Card-Key-Auth 708 and Card-Key-DEK 720) for that particular card. Using the card master keys (Card-Key-Auth 708 and Card-Key-DEK 720), the counter (pATC) field of the received message may be used to derive the session keys (Aut-Session-Key 732 and DEK-Session-Key 710) for that particular card. Cryptogram B 718 may be decrypted using the DEK-Session-KEY, which yields cryptogram A 714 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 714, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 732. Input data 706 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x'80' byte to the end of input data and 0x'00' bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC mode of the symmetric encryption algorithm. This allows the “scrambling” from block to block without having to pre-establish either a fixed or dynamic IV.

By including the pATC as part of the data included in the MAC cryptogram, the authentication service may be configured to determine if the value conveyed in the clear data has been tampered with. Moreover, by including that version in the one or more crypto grams, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and authentication may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 712, the data 706 is processed through the MAC using Aut-Session-Key 732 to produce MAC output (cryptogram A) 714, which is encrypted.

In order to provide additional protection against brute force attacks exposing the keys on the card, it is desirable that the MAC output (cryptogram A) 714 be enciphered. In some examples, data or cryptogram A 714 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 710. In the encryption operation 716, data or cryptogram A 714 and RND are processed using DEK-Session-Key 710 to produce encrypted data, cryptogram B 718. The MAC output (cryptogram A) 714 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x'0000000000000000' may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

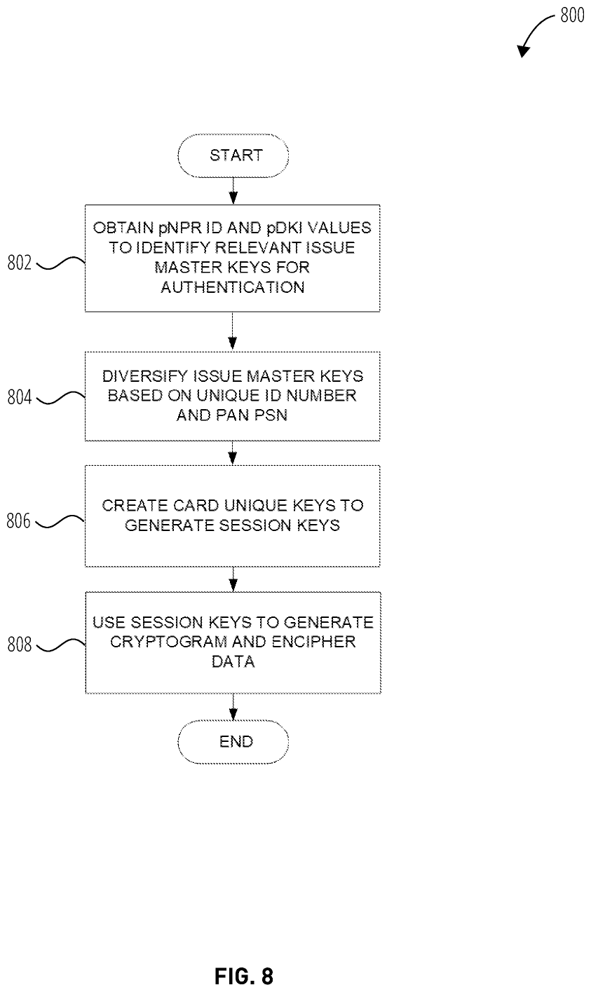

FIG. 8 illustrates a method 800 for generating a cryptogram. For example, at block 802, a network profile record ID (pNPR) and a derivation key index (pDKI) may be used to identify which issuer master keys to use in cryptographic processes for authentication. In some examples, the method 800 may include performing authentication to retrieve values of the pNPR and the pDKI for a contactless card at the time of authentication.

At block 804, issuer master keys may be diversified by combining them with the card's unique ID number (pUID) and a Personal Area Network (PAN) sequence number (PSN) of one or more applets, for example, a payment applet.

At block 806, Card-Key-Auth and Card-Key-DEK (unique card keys) may be created by diversifying the issuer master keys to generate session keys which may be used to generate a MAC cryptogram.

At block 808, the keys used to generate the MAC cryptogram and encipher data in the one or more applets may comprise the session keys of block 806 based on card unique keys (Card-Key-Auth and Card-Key-DEK). In some examples, these session keys may be generated by the one or more applets and derived by using a pATC, resulting in session keys Aut-Session-Key and DEK-Session-Key.

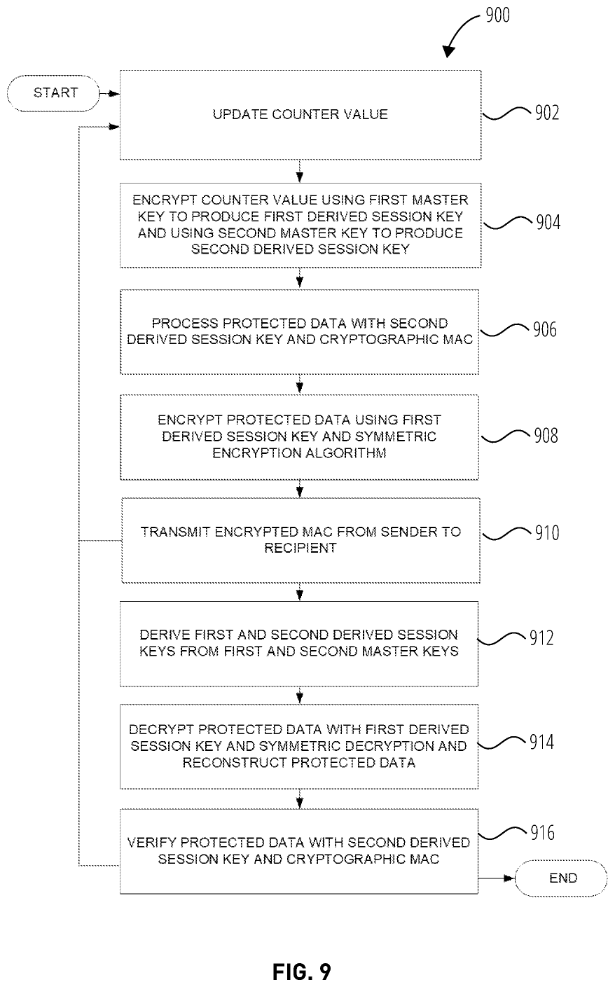

FIG. 9 depicts an exemplary process 900 illustrating key diversification according to one example. Initially, a sender and a recipient may be provisioned with two different master keys. For example, a first master key may comprise a data encryption master key, and a second master key may comprise a data integrity master key. The sender has a counter value, which may be updated at block 902, and other data, such as data to be protected, which it may secure share with the recipient.

At block 904, the counter value may be encrypted by the sender using the data encryption master key to produce a data encryption derived session key, and the counter value may also be encrypted by the sender using the data integrity master key to produce a data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 906, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 908, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 910, the encrypted MAC is transmitted, from the sender to the recipient, with sufficient information to identify additional secret information (such as shared secret, master keys, etc.), for verification of the described cryptogram.

At block 912, the recipient uses the received counter value to independently derive the two derived session keys from the two master keys as explained above.

At block 914, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 916, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 902) and a new set of session keys may be created (at block 910). In some examples, the combined random data may be discarded.

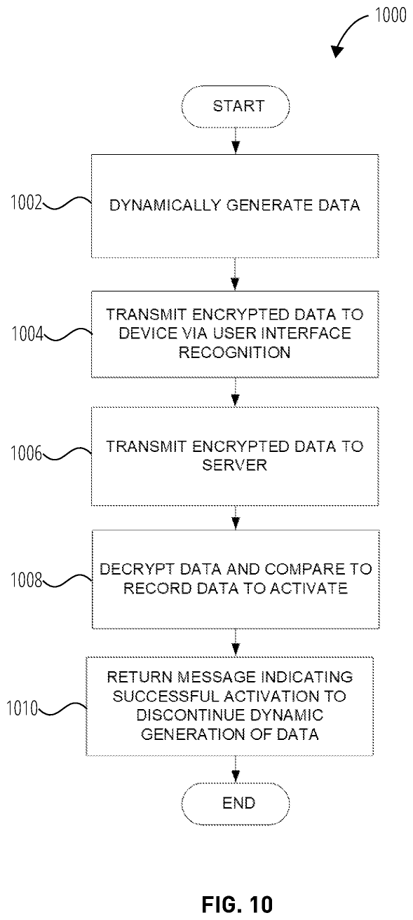

FIG. 10 illustrates a method 1000 for card activation according to an example embodiment. For example, card activation may be completed by a system including a card, a device, and one or more servers. The card, the device, and the one or more servers may reference same or similar components that were previously explained, such as the contactless card 102, the client device 104, and the server.

In block 1002, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1004, one or more portions of the dynamically generated data may be communicated to an application of the device via NFC or other wireless communication. For example, a tap of the card proximate to the device may allow the application of the device to read the one or more portions of the data associated with the card. In some examples, if the device does not comprise an application to assist in activation of the card, the tap of the card may direct the device or prompt a user to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the server.

In block 1006, the one or more encrypted portions of data may be communicated to one or more servers, such as a card issuer server. For example, the one or more encrypted portions of data may be transmitted from the device to the card issuer server for activation of the card.

In block 1008, the one or more servers may decrypt the one or more encrypted portions of data via the systems and methods disclosed herein. For example, the one or more servers may receive the encrypted portions of data from the device and may decrypt the same in order to compare received data to record data accessible to the one or more servers. If a resulting comparison of one or more decrypted portions of the data by the one or more servers yields a successful match, the card may be activated. If the resulting comparison of the one or more decrypted portions of the data by the one or more servers yields an unsuccessful match, one or more processes may take place. For example, responsive to a determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of an unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1010, the one or more servers may transmit a return message based on successful activation of the card. For example, the device may be configured to receive output from the one or more servers indicative of the successful activation of the card by the one or more servers. The device may be configured to display a message indicating the successful activation of the card. Once the card has been activated, the card may be configured to discontinue dynamically generating data so as to avoid fraudulent use. In this manner, the card may not be activated thereafter, and the one or more servers are notified that the card has already been activated.

FIGS. 1-10 are generally directed to systems and methods to authenticate a contactless card based on information on the contactless card. However, as previously discussed, some embodiments disclosed herein can include systems and methods for provisioning escrow and securing purchases.

For example, in some embodiments, systems and methods disclosed herein can receive first encrypted data, such as a first cryptogram, from a first contactless card of a seller and decrypt the first encrypted data to authenticate the first contactless card. When the first contactless card has been authenticated, systems and methods disclosed herein can ensure that the seller is doubly trusted by identifying both personally identifiable information of the seller and a bank or credit account number for the seller and, responsive thereto, offer the item for sale at a purchase price via a website or a mobile application. The first encrypted data can be received via a short-range communication antenna of a first mobile device of the seller. As such, with a single tap of the first contactless card on the first mobile device to bring the first contactless card within a communication range of the short-range communication antenna of the first mobile device, systems and methods disclosed herein can validate both an identity of the seller and banking information for the seller, set up or access an account for the seller with the website or the mobile application to sell the item for sale, and establish a bank or credit account for receiving an amount of money equal to the purchase price from the buyer upon completion of the sale.

Systems and methods disclosed herein can also receive second encrypted data, such as a second cryptogram, from a second contactless card of the buyer and decrypt the second encrypted data to authenticate the second contactless card. When the second contactless card has been authenticated, systems and methods disclosed herein can ensure that the buyer is doubly trusted by identifying both personally identifiable information of the buyer and a bank or credit account number for the buyer and, responsive thereto, retrieve an amount of money equal to the purchase price from a bank or credit account matching the bank or credit account number for the buyer and place the money in an escrow account. The second encrypted data can be received via a short-range communication antenna of a second mobile device of the buyer. As such, with a single tap of the second contactless card on the second mobile device to bring the second contactless card within a communication range of the short-range communication antenna of the second mobile device, systems and methods disclosed herein can validate both an identity of the buyer and banking information for the buyer, set up or access an account for the buyer with the website or the mobile application to purchase the item for sale, and authorize a transfer of the amount of money equal to the purchase price to the escrow account.

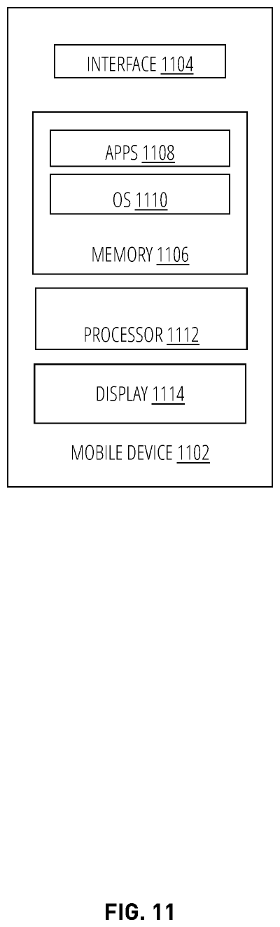

The money from the buyer can be held in the escrow account until the buyer examines the item for sale and/or the seller transfers possession of the item for sale to the buyer. In this regard, to confirm that the buyer is in possession of the item for sale, systems and methods disclosed herein can receive the second encrypted data from the second contactless card a second time and decrypt the second encrypted data to authenticate the second contactless card a second time. When the second contactless card has been authenticated the second time, systems and methods disclosed herein can release the money in the escrow account to the bank or credit account matching the bank or credit account number for the seller. As such, with a single tap of the second contactless card on the second mobile device to bring the second contactless card within the communication range of the short-range communication antenna of the second mobile device, systems and methods disclosed herein can validate both the identity of the buyer and the banking information for the buyer and authorize a transfer of the money in the escrow account to the bank or credit account matching the bank or credit account for the seller. FIGS. 11-15 are generally directed to these embodiments and provide additional details thereof.

FIG. 11 is a block diagram that illustrates an example of a mobile device 1102 in accordance with disclosed embodiments. It is to be understood that the mobile device 1102 can be the same as or similar to the client device 104 and be a mobile device of a seller of an item for sale and/or a mobile device of a buyer of the item for sale.

As seen, the mobile device 1102 can include an interface 1104, a memory 1106, a processor 1112, and a display device 1114. The memory 1106 can be configured to store computer instructions configured to be executed by the processor 1112 to cause the processor 1112 to execute certain actions, and the computer instructions can be part of applications 1108 and/or an operating system 1110.

In some embodiments, the interface 1104 can include one or more antennas, such as a short-range communication antenna, one or more user interface devices, such as a key pad with hard or soft keys, and/or a camera, a scanner, a card reader, or another device capable of reading or capturing images, information, or data within its field of view. Additionally or alternatively, the interface 1104 can include a WiFi interface, a Bluetooth interface, an NFC interface, a serial bus interface, a universal serial bus (USB), and so forth.

In some embodiments, the memory 1106 can be any type of memory configured to store instructions to be processed by the processor 1112. Examples of the memory 1106 can include volatile or non-volatile memory, removable or non-removable memory, erasable or non-erasable memory, writeable or re-writeable memory, and so forth.

In some embodiments, the processor 1112 can be any type of processor, microprocessor, circuit, circuit element (e.g., transistor, resistor, capacitor, inductor, and so forth), integrated circuit, application specific integrated circuit (ASIC), programmable logic device (PLD), digital signal processor (DSP), field programmable gate array (FPGA), multi-core processor, and so forth.

In some embodiments, the display device 1114 can include a display screen or other output device for displaying data, information, and/or graphics to a user of the mobile device 104.

As explained above, the memory 1106 can include the applications 1108 and/or the operating system 1110. The applications 1108 can include any type of application configured to operate on the mobile device 1102. For example, the applications 1108 can include mobile banking applications, mobile credit card applications, business applications, social networking applications, marketplace applications, classifieds applications, communication applications, business productivity applications (e.g., email, word processor, spreadsheet, etc.), storefront applications, money transfer applications, gaming applications, merchant applications, shopping mobile applications, and so forth.

The applications 1108 can be configured to operate within the operating system 1110. In some embodiments, the operating system 1110 can be an Android® operating system, Apple iOS® operating system, Windows Mobile Operating System®, and so forth. The operating system 1110 can be configured to provide services and instructions that execute and enable the applications 1108 to operate with hardware. For example, the operating system 1110 can be configured to operate with the hardware associated with the processor 1112 to process detections made by the interface 1104 and/or to transmit corresponding signals and data via the interface 1104. In some embodiments, the operating system 1110 can provide data to the applications 1108 processed by the operating system 1110. The applications 1108 can process such data, including performing authentications of the data, communicating the data to other devices or servers, and so forth. In some embodiments, at least a portion of the operating system 1110 can be configured to perform one or more authentication steps.

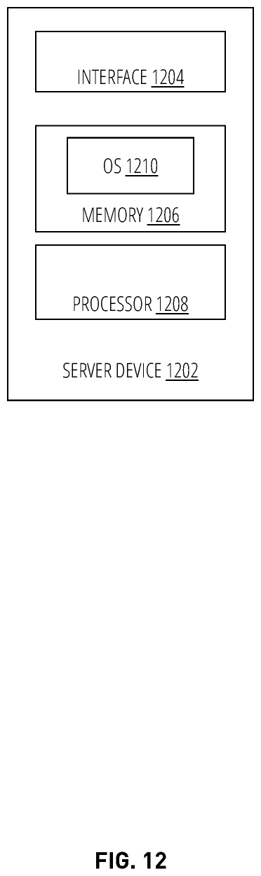

FIG. 12 is a block diagram that illustrates an example of a server device 1202 in accordance with disclosed embodiments. It is to be understood that the server device 1202 can be the same as or similar to the server 108 and/or the server 202.

As seen, the server device 1202 can include an interface 1204, a memory 1206, and a processor 1208. The memory 1206 can be configured to store computer instructions configured to be executed by the processor 1208 to cause the processor 1208 to execute certain actions.

The computer instructions can be part of an operating system 1210.

In some embodiments, the interface 1204 can be wired or wireless. For example, the interface 1204 can include a WiFi interface, a Bluetooth interface, an NFC interface, a serial bus interface, a universal serial bus (USB), and so forth.

In some embodiments, the memory 1206 can be any type of memory configured to store instructions to be processed by the processor 1208. Examples of the memory 1206 can include volatile or non-volatile memory, removable or non-removable memory, erasable or non-erasable memory, writeable or re-writeable memory, and so forth.

In some embodiments, the processor 1208 can be any type of processor, microprocessor, circuit, circuit element (e.g., transistor, resistor, capacitor, inductor, and so forth), integrated circuit, application specific integrated circuit (ASIC), programmable logic device (PLD), digital signal processor (DSP), field programmable gate array (FPGA), multi-core processor, and so forth.

As explained above, the memory 1206 can include the operating system 1210. In some embodiments, the operating system 1210 can include a Microsoft Windows server operating system, a Linux/Unix server operating system, a cloud server operating system, such as an Amazon AWS operating system, and so forth. The operating system 1210 can be configured to provide services and instructions that execute to operate with hardware. For example, the operating system 1210 can be configured to operate with the hardware associated with the processor 1208 to process signals and data received by the interface 1204, including performing authentication of such data. In some embodiments, at least a portion of the operating system 1210 can be configured to perform one or more authentication steps.

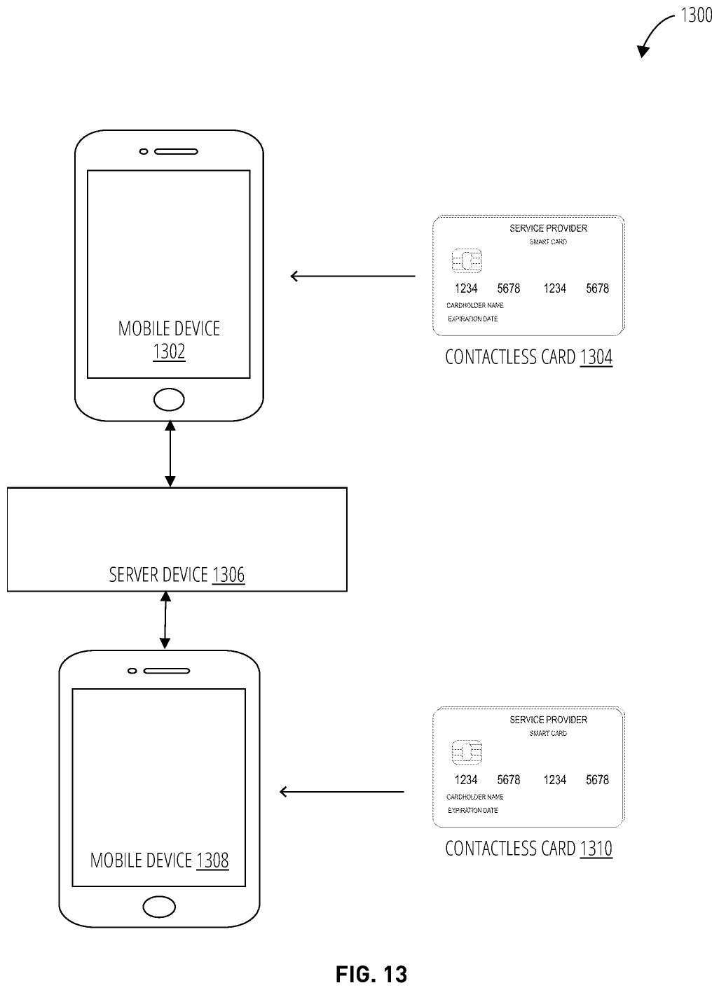

FIG. 13 is a block diagram that illustrates an example of a system 1300 in accordance with disclosed embodiments. As seen, the system 1300 can include a mobile device 1302, a contactless card 1304, a mobile device 1308, a contactless card 1310, and a server device 1306 in communication with the mobile device 1302 and the mobile device 1308. It is to be understood that the mobile device 1302 and the mobile device 1308 can be the same as or similar to the mobile device 1102 and/or the client device 104. In some embodiments, the mobile device 1302 can be a mobile device of a seller of an item for sale via a website or a mobile application, and the mobile device 1308 can be a mobile device of a buyer of the item for sale. It is also to be understood that the server device 1306 can be the same as or similar to the server device 1202, the server 108, and/or the server 202 and that the contactless card 1304 can be the same as or similar to the contactless card 102. In particular, the contactless card 1304 can be associated with a customer account of a bank or a company that issued the contactless card 1304 to the seller, and the contactless card 1310 can be associated with a customer account of a bank or a company that issued the contactless card 1310 to the buyer.

In some embodiments, the server device 1306 can receive first encrypted data, such as a first cryptogram, from the contactless card 1304 prior to enabling the seller to offer the item for sale via the website or the mobile application. For example, in some embodiments, the seller can tap or otherwise bring the contactless card 1304 within a communication range of the mobile device 1302, and the mobile device 1302 can read the first encrypted data from the contactless card 1304 and/or the contactless card 1304 can transmit the first encrypted data to the mobile device 1302. In operation, the mobile device 1302 can transmit the first encrypted data to the server device 1306, and the server device 1306 can decrypt the first encrypted data to authenticate the contactless card 1304. After the server device 1306 authenticates the contactless card 1304, the server device 1306 can identify personally identifiable information of the seller and a bank or credit account number for the seller and, responsive thereto, offer the item for sale at a purchase price via the website or the mobile application. For example, in some embodiments, the server device 1306 can push to the website or the mobile application, either directly or via a third party server, data related to the item and the purchase price for display thereon. In some embodiments, the server device 1306 can identify the purchase price responsive to user input from the seller.

The server device 1306 can also receive second encrypted data, such as a second cryptogram, from the contactless card 1308 prior to enabling the buyer to offer to purchase the item for sale. For example, in some embodiments, the buyer can tap or otherwise bring the contactless card 1310 within a communication range of the mobile device 1308, and the mobile device 1308 can read the second encrypted data from the contactless card 1310 and/or the contactless card 1310 can transmit the second encrypted data to the mobile device 1308. In operation, the mobile device 1308 can transmit the second encrypted data to the server device 1306, and the server device 1306 can decrypt the second encrypted data to authenticate the contactless card 1310. After the server device 1306 authenticates the contactless card 1310, the server device 1306 can identify personally identifiable information of the buyer and a bank or credit account number for the buyer and, responsive thereto, retrieve an amount of money equal to the purchase price from a bank or credit account matching the bank or credit account number for the buyer and place the money in an escrow account. For example, in some embodiments, the server device 1306 can communicate with a third party server for a banking or credit institution to retrieve the money and/or place the money in the escrow account.

In some embodiments, the server device 1306 can receive the personally identifiable information of the seller and/or the bank or credit account number for the seller from the contactless card 1304. Similarly, in some embodiments, the server device 1306 can receive the personally identifiable information of the buyer and/or the bank or credit account number for the buyer from the contactless card 1310. Additionally or alternatively, in some embodiments, the server device 1306 can use the first encrypted data to retrieve the personally identifiable information of the seller and/or the bank or credit account number for the seller from a banking or credit authorization system, such as the third party server for the banking or credit institution. Similarly, in some embodiments, the server device 1306 can use the second encrypted data to retrieve the personally identifiable information of the buyer and/or the bank or credit account number for the buyer from the banking or credit authorization system, such as the third party server for the banking or credit institution. In some embodiments, responsive to identifying the personally identifiable information of the seller and the bank or credit account number for the seller, the server device 1306 can create or identify a shopping account for the seller on the website or the mobile application. Similarly, in some embodiments, responsive to identifying the personally identifiable information of the buyer and the bank or credit account number for the buyer, the server device 1306 can create or identify a shopping account for the buyer on the website or the mobile application.

The contactless card 1304 can be associated with a first customer account, and the contactless card 1310 can be associated with a second customer account. As such, in some embodiments, the server device 1306 can identify the first customer account to authenticate the contactless card 1304 and identify the second customer account to authenticate the contactless card 1310. In particular, in some embodiments, the server device 1306 can decrypt first protected data in the first encrypted data and compare the first protected data to first record data associated with the first customer account and stored on the server device 1306. When the first protected data matches the first record data, the server device 1306 can authenticate the first contactless card 1304. Similarly, in some embodiments, the server device 1306 can decrypt second protected data in the second encrypted data and compare the second protected data to second record data associated with the second customer account and stored on the server device 1306. When the second protected data matches the second record data, the server device 1306 can authenticate the second contactless card.

It is to be understood that, in some embodiments, the contactless card 1304 and the contactless card 1310 will not be authenticated unless registered with the server device 1306 so as to be associated with the first customer account and the second customer account, respectively. In this regard, without such registration and association, the server device 1306 may not be capable of decrypting the first encrypted data, the second encrypted data, the first protected data in the first encrypted data, and/or the second protected data in the second encrypted data, for example, due to lacking required keys and the like. Additionally or alternatively, without such registration and association, the server device 1306 may be able to decrypt the first encrypted data, the second encrypted data, the first protected data in the first encrypted data, and/or the second protected data in the second encrypted data, but may not be able to match the first protected data or the second protected data to any record data stored for registered cards. In this regard, the contactless card 1304 can be associated with the first customer account and the contactless card 1310 can be associated with the second customer account in a database or a data store maintained by the server device 1306. As such, the mobile device 1302 can provide the first encrypted data received from the contactless card 1304 as well identifying data to the server device 1306, and the server device 1306 can utilize such received information to identify the first customer account and verify that the first customer account is associated with the contactless card 1304. Similarly, the mobile device 1308 can provide the second encrypted data received from the contactless card 1310 as well as identifying data to the server device 1306, and the server device 1306 can utilize such received information to identify the second customer account and verify that the second customer account is associated with the contactless card 1310.

In some embodiments, after the seller offers the item for sale via the website or the mobile application and after the buyer offers to purchase the item for sale, the server device 1306 can identify a location of the seller and a location of the buyer. For example, in some embodiments, the server device 1306 can use an address for the seller included in the personally identifiable information of the seller to identify the location of the seller and/or use an address for the buyer included in the personally identifiable information of the buyer to identify the location of the buyer. Additionally or alternatively, in some embodiments, the server device 1306 can use a cellular or GPS location of the mobile device 1302 to identify the location of the seller and/or use a cellular or GPS location of the mobile device 1308 to identify the location of the buyer.

When the sale requires the item for sale to be picked up in person, the server device 1306 can identify a distance between the location of the buyer and the location of the seller and, responsive to the distance being greater than a predetermined threshold, reject the sale from the seller to the buyer. For example, the server device 1306 can return the money from the escrow account to the bank or credit account matching the bank or credit account number for the buyer.

Additionally or alternatively, when the sale requires the item for sale to be picked up in person, the server device 1306 can identify a recommended exchange location in between the location of the buyer and the location of the seller. For example, the server device 1306 can access area maps to identify a third party location, such as a public facility, within a predetermined distance of both the location of the seller and the location of the buyer. In some embodiments, the server device 1306 can also identify an exchange time for the buyer and the seller to meet and, when the location of the seller or the location of the buyer are more than a predetermined distance away from the recommended exchange location at the exchange time or within a predetermined period of time thereafter, reject the sale from the buyer to the seller.

Additionally or alternatively, in an effort to keep the seller and the buyer safe and prevent fraudulent activity, the server device 1306 can reject the sale from the seller to the buyer when the location of the seller or the location of the buyer is within a predetermined high crime area and/or when the bank or credit account matching the bank or credit account number for the seller or the bank or credit account matching the bank or credit account number for the buyer has been a party to prior fraudulent activity. For example, the server device 1306 can maintain or access a database that identifies account numbers associated with any fraudulent activity.

To complete the sale, the server device 1306 can receive the second encrypted data from the contactless card 1308 a second time. For example, in some embodiments, the buyer can tap or otherwise bring the contactless card 1310 within the communication range of the mobile device 1308 after satisfactory inspection of the item for sale, either in person or virtually, and the mobile device 1308 can read the second encrypted data from the contactless card 1310 and/or the contactless card 1310 can transmit the second encrypted data to the mobile device 1308. Additionally or alternatively, when the buyer and the seller are together to complete the sale, the buyer can tap or otherwise bring the contactless card 1310 within the communication range of the mobile device 1302, and the mobile device 1302 can read the second encrypted data from the contactless card 1310 and/or the contactless card 1310 can transmit the second encrypted data to the mobile device 1302. Additionally or alternatively, when the buyer and the seller are together at some third party pick up location, the buyer can tap or otherwise bring the contactless card 1310 within a communication range of a third party device, and the third party device can read the second encrypted data from the contactless card 1310 and/or the contactless card 1310 can transmit the second encrypted data to the third party device. In operation, the mobile device 1308, the mobile device 1302, and/or the third party device can transmit the second encrypted data to the server device 1306, and the server device 1306 can decrypt the second encrypted data to authenticate the contactless card 1310 a second time. After the server device 1306 authenticates the contactless card 1310 the second time, the server device 1306 can release or cause to be released the money in the escrow account to the bank or credit account matching the bank or credit account number for the seller. For example, in some embodiments, the server device 1306 can communicate with one or more third party servers for one or more banking or credit institutions to transfer the money from the escrow account to the bank or credit account matching the bank or credit account number for the seller. In some embodiments, the server device 1306 can cause a notification message to be sent to the mobile device 1302 when the money in the escrow account is sent to the bank or credit account matching the bank or credit account number of the seller to notify the seller thereof so the seller can cede possession of the item for sale, knowing that proper funds therefor have been secured.

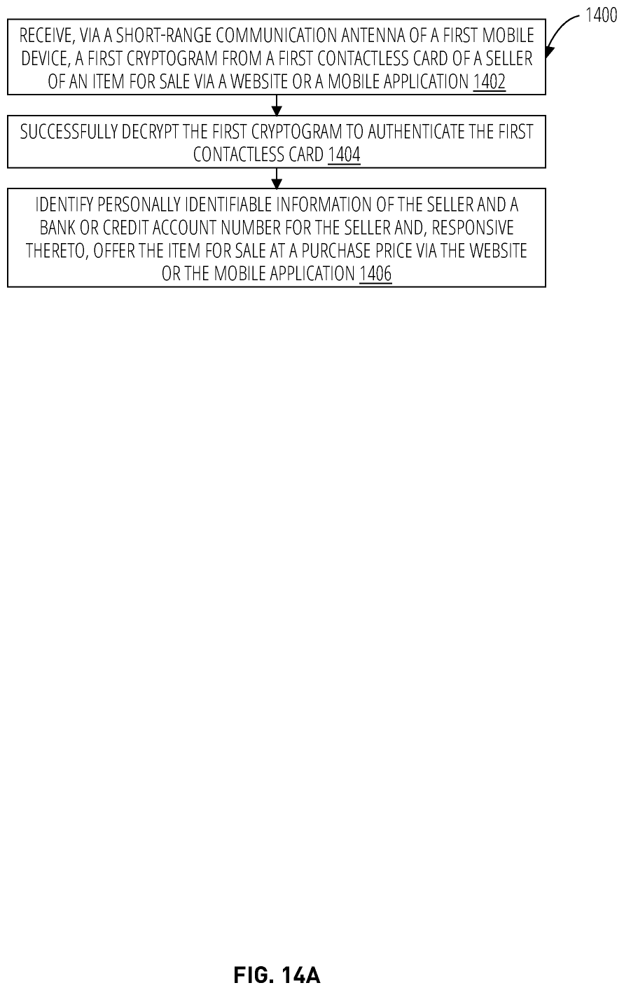

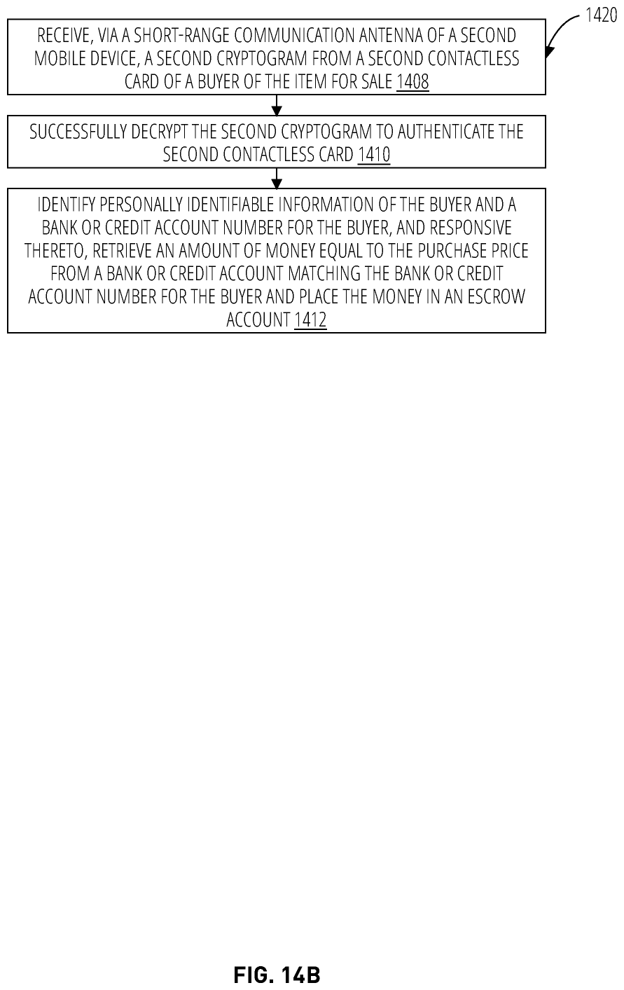

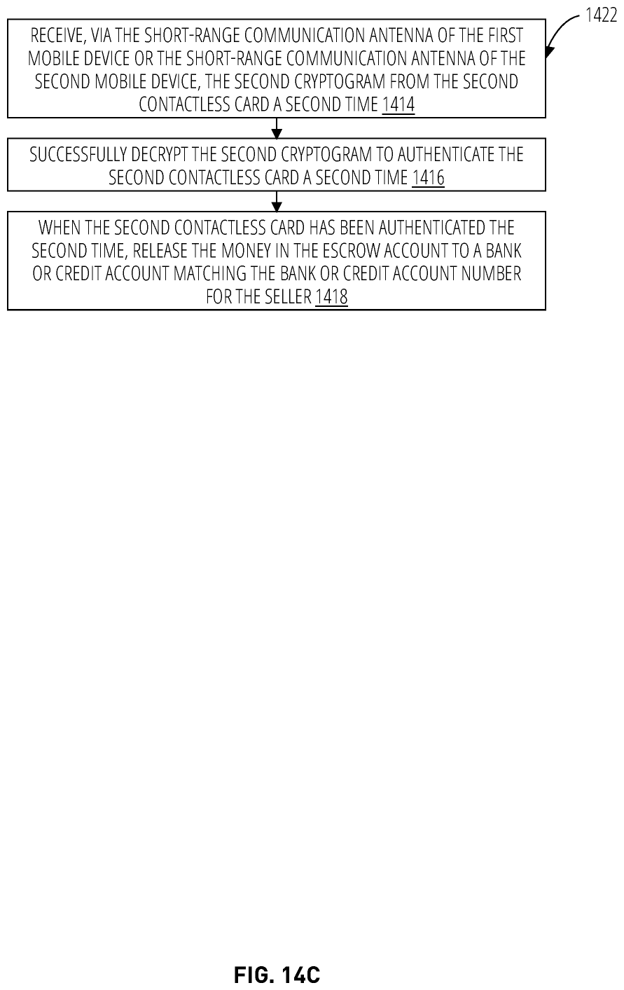

FIG. 14A is a flow chart that illustrates an example of a method 1400 of securing an offer for sale in accordance with disclosed embodiments, FIG. 14B is a flow chart that illustrates an example of a method 1420 of securing an offer for purchase in accordance with disclosed embodiments; and FIG. 14C is a flow chart that illustrates an example of a method 1422 of securing a purchase in accordance with disclosed embodiments. It is to be understood that the methods 1400, 1420, and 1422 can be executed separately, together, sequentially, or simultaneously. In some embodiments, a server device, such as the server device 1306, the server device 1202, the server 108, and/or the server 202, can execute some or all of the methods 1400, 1420, and 1422.

As seen in FIG. 14A, the method 1400 can include receiving, via a short-range communication antenna of a first mobile device, first encrypted data, such as a first cryptogram, from a first contactless card of a seller of an item for sale via a website or a mobile application as in 1402. For example, in some embodiments, the method 1400 can include receiving the first encrypted data from the first mobile device responsive to the first contactless card being within a communication range of the short-range communication antenna of the first mobile device and the first mobile device receiving the first encrypted data from the first contactless card.

Then, the method 1400 can include successfully decrypting the first encrypted data to authenticate the first contactless card as in 1404. The first contactless card can be associated with a first customer account. As such, in some embodiments, the method 1400 can include identifying the first customer account to authenticate the first contactless card. In particular, in some embodiments, the method 1400 can include decrypting first protected data in the first encrypted data and comparing the first protected data to first record data associated with the first customer account and stored on a server device. When the first protected data matches the first record data, the method 1400 can include authenticating the first contactless card.

Finally, the method 1400 can include identifying personally identifiable information of the seller and a bank or credit account number for the seller and, responsive thereto, offering the item for sale at a purchase price via the website or the mobile application as in 1406. For example, in some embodiments, the method 1400 can include pushing to the website or the mobile application, either directly or via a third party server, data related to the item and the purchase price for display thereof.

In some embodiments, the method 1400 can include receiving the personally identifiable information of the seller and/or the bank or credit account number for the seller from the first contactless card via the first mobile device. Additionally or alternatively, in some embodiments, the method 1400 can include using the first encrypted data to retrieve the personally identifiable information of the seller and/or the bank or credit account number for the seller from a banking or credit authorization system, such as a third party server for a banking or credit institution.

As seen in FIG. 14B, the method 1420 can include receiving, via a short-range communication antenna of a second mobile device, second encrypted data, such as a second cryptogram, from a second contactless card of a buyer of the item for sale as in 1408. For example, in some embodiments, the method 1420 can include receiving the second encrypted data from the second mobile device responsive to the second contactless card being within a communication range of the short-range communication antenna of the second mobile device and the second mobile device receiving the second encrypted data from the second contactless card.

Then, the method 1420 can include successfully decrypting the second encrypted data to authenticate the second contactless card as in 1410. The second contactless card can be associated with a second customer account. As such, in some embodiments, the method 1420 can include identifying the second customer account to authenticate the second contactless card. In particular, in some embodiments, the method 1420 can include decrypting second protected data in the second encrypted data and comparing the second protected data to second record data associated with the second customer account and stored on the server device. When the second protected data matches the second record data, the method 1420 can include authenticating the second contactless card.

Finally, the method 1420 can include identifying personally identifiable information of the buyer and a bank or credit account number for the buyer, and responsive thereto, retrieving an amount of money equal to the purchase price from a bank or credit account matching the bank or credit account number for the buyer and placing the money in an escrow account as in 1412. For example, in some embodiments, the method 1420 can include communicating with the third party server for the banking or credit authorization system to retrieve the money and/or place the money in the escrow account.

In some embodiments, the method 1420 can include receiving the personally identifiable information of the buyer and/or the bank or credit account number for the buyer from the second contactless card via the second mobile device. Additionally or alternatively, in some embodiments, the method 1420 can include using the second encrypted data to retrieve the personally identifiable information of the buyer and/or the bank or credit account number for the buyer from the banking or credit authorization system, such as the third party server for the banking or credit institution.

In some embodiments, the method 1400, the method 1420, and/or the method 1422 can include identifying a location of the seller and a location of the buyer. For example, in some embodiments, the method 1400, the method 1420, and/or the method 1422 can include using an address for the seller included in the personally identifiable information to identify the location of the seller and/or using an address for the buyer included in the personally identifiable information of the buyer to identify the location of the buyer. Additionally or alternatively, the the method 1400, the method 1420, and/or the method 1422 can include using a cellular or GPS location of the first mobile device to identify the location of the seller and/or using a cellular or GPS location of the second mobile device to identify the location of the buyer. When the location of the seller or the location of the buyer is within a predetermined high crime area and/or when the bank or credit account matching the bank or credit account number for the seller or the bank or credit account matching the bank or credit account number for the buyer has been a party to prior fraudulent activity, the method 1400, the method 1420, and/or the method 1422 can include rejecting the sale from the seller to the buyer, for example, by returning the money from the escrow account to the bank or credit account matching the bank or credit account number for the buyer.

When the sale requires the item for sale to be picked up in person, the method 1400, the method 1420, and/or the method 1422 can also include identifying a recommended exchange location in between the location of the buyer and the location of the seller and/or an exchange time for the buyer and the seller to meet. However, when a distance between the location of the buyer and the location of the seller is greater than a predetermined threshold, the method 1400, the method 1420, and/or the method 1422 can include rejecting the sale from the seller to the buyer. Similarly, when the location of the seller or the location of the buyer are more than a predetermined distance away from the recommended exchange location at the exchange time or within a predetermined period of time thereafter, the method 1400, the method 1420, and/or the method 1422 can include rejecting the sale from the buyer to the seller.

As seen in FIG. 14C, after the seller offers the item for sale via the website or the mobile application and after the buyer offers to purchase the item for sale, the method 1422 can include receiving, via the short-range communication antenna of the first mobile device or the short-range communication antenna of the second mobile device, the second encrypted data from the second contactless card a second time as in 1414. For example, in some embodiments, the method 1422 can include receiving the second encrypted data from first mobile device or the second mobile device responsive to the second contactless card being within a communication range of the short-range communication antenna of the first mobile device or the second mobile device and the first mobile device or the second mobile device receiving the second encrypted data from the second contactless card.

Then, the method 1422 can include successfully decrypting the second encrypted data to authenticate the second contactless card a second time as in 1416. As explained above, the second contactless card can be associated with the second customer account. As such, in some embodiments, the method 1422 can include identifying the second customer account to authenticate the second contactless card. In particular, in some embodiments, the method 1422 can include decrypting the second protected data in the second encrypted data and comparing the second protected data to the second record data associated with the second customer account and stored on the server device. When the second protected data matches the second record data, the method 1422 can include authenticating the second contactless card.

When the second contactless card has been authenticated the second time, the method 1422 can include releasing the money in the escrow account to a bank or credit account matching the bank or credit account number for the seller as in 1418. For example, in some embodiments, the method 1422 can include communicating with one or more third party servers for one or more banking or credit authorization institutions to transfer the money from the escrow account to the bank or credit account matching the bank or credit account number for the seller.

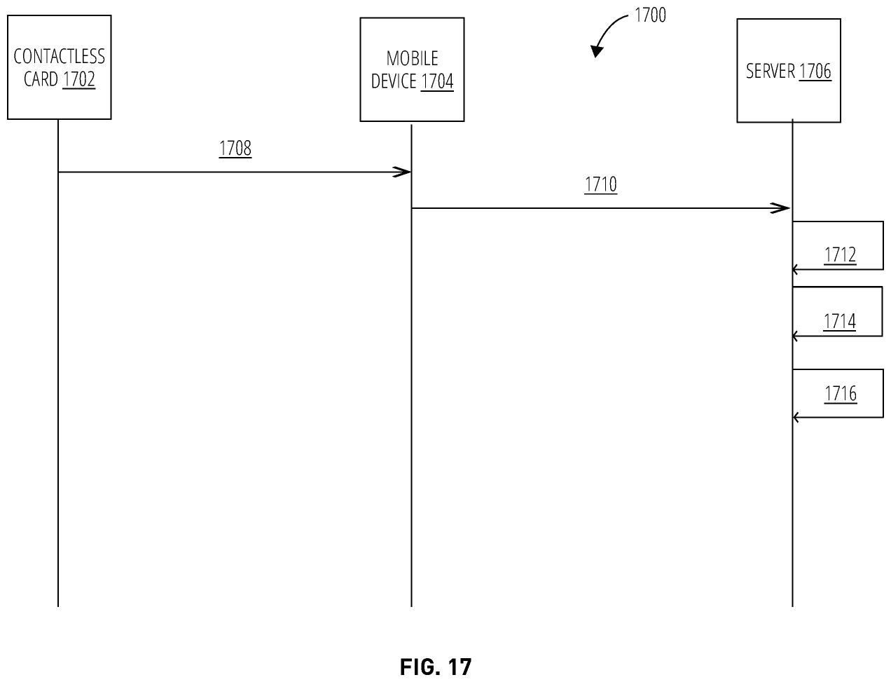

FIG. 17 illustrates an example of a sequence flow 1700 in accordance with disclosed embodiments. A contactless card 1702 can include a contactless card of a seller of an item for sale via a website or a mobile application or a contactless card of a buyer of the item for sale and be the same as or similar to the contactless card 1304 and/or the contactless card 102. A mobile device 1704 can include a mobile device of the seller or a mobile device of the buyer and be the same as or similar to the mobile device 1302, the mobile device 1308, the mobile device 1102, and/or the client device 104. A server 1706 can be the same as or similar to the server device 1306, the server device 1202, the server 108, and/or the server 202, and in some embodiments, the server 1706 can perform decryption and/or authentication.

The contactless card 1702 can be tapped on or brought within a communication range of the mobile device 1704 and can exchange information with the mobile device 1704. Line 1708 can represent communication between the contactless card 1702 and the mobile device 1704 and can include encrypted data, such as a cryptogram, stored on the contactless card 1702 and provided to the mobile device 1704. In some embodiments, protected data in the encrypted data can be encrypted using systems and methods described herein, for example, as discussed in FIGS. 1-10. In some embodiments, the communication between the contactless card 1702 and the mobile device 1704 can also include personally identifiable information of a holder of the contactless card 1702 and/or a bank or credit account number for the holder of the contactless card 1702.

In some embodiments, communications between the contactless card 1702 and the mobile device 1704 can include NFC communications in accordance with one or more NFC protocols. However, embodiments disclosed herein are not so limited and can include other wireless technologies in addition to or as an alternative to NFC, such as other short-range communication protocols.

In some embodiments, the mobile device 1704 can operate as a pass-through and transmit the encrypted data and other data, including, for example, the personally identifiable information and the bank or credit account number, to the server 1706. Line 1710 can represent communication between the mobile device 1704 and the server 1706.

Upon receipt of the encrypted data, the server 1706 can decrypt the encrypted data to authenticate the contactless card 1702 at 1712, for example, as discussed in FIGS. 1-10. In some embodiments, the server 1706 can use some of the other data received from the mobile device 1704 to identify a customer account associated with the contactless card 1702. In particular, in some embodiments, the server 1706 can decrypt protected data in the encrypted data and compare the protected data to record data associated with the customer account and stored on the server 1706. When the protected data matches the record data, the server 1706 can authenticate the contactless card 1702.

After decrypting the encrypted data and when the contactless card 1702 is of the seller of the item for sale, the server 1702 can identify the personally identifiable information of the seller and the bank or credit account number for the seller at 1714 and, responsive thereto, offer the item for sale at a purchase price via the website or the mobile application at 1716. However, after decrypting the encrypted data a first time and when the contactless card 1702 is of the buyer of the item for sale, the server 1702 can identify the personally identifiable information of the buyer and the bank or credit account number for the buyer at 1714 and, responsive thereto, retrieve an amount of money equal to the purchase price from a bank or credit account matching the bank or credit account number for the buyer and place the money in an escrow account at 1716. However, after decrypting the encrypted data a second time and when the contactless card 1702 is of the buyer of the item for sale, the server 1702 can release or cause to be released the money in the escrow account to the bank or credit account matching the bank or credit account number for the seller at 1714.

It is to be understood that the server 1706 can process any data, information, and/or requests received from the mobile device 1704 either partially or fully. For example, in some embodiments, the server 1706 can decrypt the encrypted data. Additionally or alternatively, in some embodiments, the server 1706 can compare received, processed, or retrieved data to data stored thereon for identification of additional data and/or for identification of matches therebetween.

It is also to be understood that the mobile device 1704 can communicate with the server 1706 via one or more wireless and/or wired connections. For example, in some embodiments, the mobile device 1704 can transmit any data, information, or requests to one or more application program interfaces (APIs) hosted by the server 1706. Additionally or alternatively, in some embodiments, the mobile device 1704 can transmit any data, information, or requests to one or more APIs hosted by a third party, such as a cloud-computing provider.

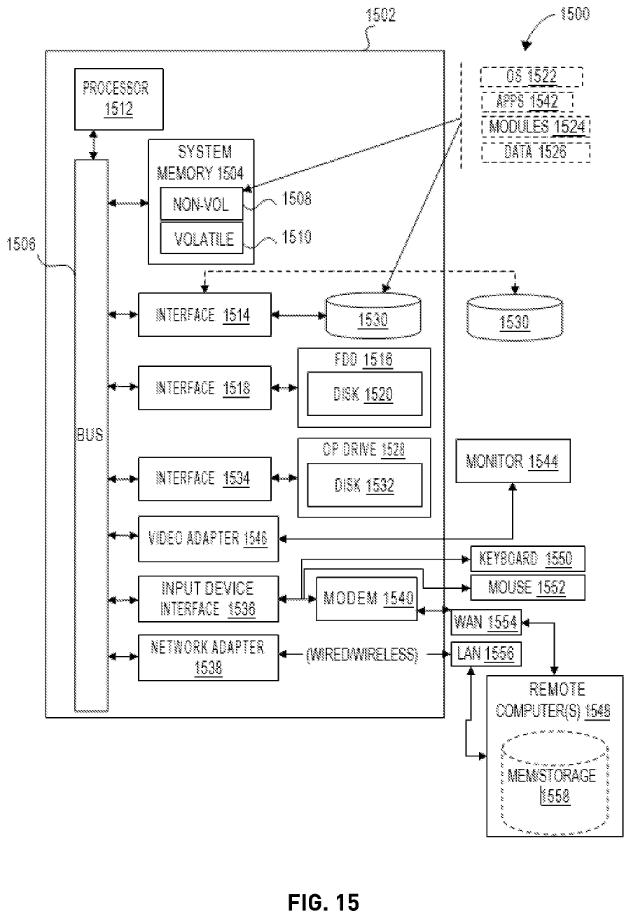

FIG. 15 illustrates an embodiment of an exemplary computer architecture 1500 suitable for implementing various embodiments as previously described. In one embodiment, the computer architecture 1500 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 15, the computing architecture 1500 includes a processor 1512, a system memory 1504 and a system bus 1506. The processor 1512 can be any of various commercially available processors.

The system bus 1506 provides an interface for system components including, but not limited to, the system memory 1504 to the processor 1512. The system bus 1506 can be any of several types of bus structure that may further interconnect to a memory bus (with or without a memory controller), a peripheral bus, and a local bus using any of a variety of commercially available bus architectures. Interface adapters may connect to the system bus 1506 via slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI(X)), Peripheral Component Interconnect (PCI) Express, Personal Computer Memory Card International Association (PCMCIA), and the like.

The computing architecture 1500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1504 may include various types of computer-readable storage media in the form of one or more higher speed memory units, such as ROM, RAM, dynamic RAM (DRAM), Double-Data-Rate DRAM (DDRAM), synchronous DRAM (SDRAM), static RAM (SRAM), programmable ROM (PROM), erasable programmable ROM (EPROM), EEPROM, flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1504 can include non-volatile 1508 and/or volatile 1510. A basic input/output system (BIOS) can be stored in the non-volatile 1508.

A computer 1502 may include various types of computer-readable storage media in the form of one or more lower speed memory units, including an internal (or external) hard disk drive 1530, a magnetic disk drive 1516 to read from or write to a removable magnetic disk 1520, and an optical disk drive 1528 to read from or write to a removable optical disk 1532 (e.g., a CD-ROM or DVD). The hard disk drive 1530, magnetic disk drive 1516 and optical disk drive 1528 can be connected to system bus 1506 by a hard disk drive (HDD) interface 1514, and a floppy disk drive (FDD) interface 1518, and an optical disk drive interface 1534, respectively. The HDD interface 1514 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1508, and volatile 1510, including an operating system 1522, one or more applications 1542, other program modules 1524, and program data 1526. In one embodiment, the one or more applications 1542, other program modules 1524, and program data 1526 can include, for example, the various applications and/or components of the systems discussed herein.

A user can enter commands and information into the computer 1502 through one or more wire/wireless input devices, for example, a keyboard 1550 and a pointing device, such as a mouse 1552. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1512 through an input device interface 1536 that is coupled to the system bus 1506 but can be connected by other interfaces such as a parallel port, IEEE 1394 serial port, a game port, a USB port, an IR interface, and so forth.

A monitor 1544 or other type of display device is also connected to the system bus 1506 via an interface, such as a video adapter 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all the elements described relative to the computer 1502, although, for purposes of brevity, only a memory and/or storage device 1558 is illustrated. The logical connections depicted include wire/wireless connectivity to a local area network 1556 and/or larger networks, for example, a wide area network 1554. Such LAN and Wide Area Network (WAN) networking environments are commonplace in offices and companies, and facilitate enterprise-wide computer networks, such as intranets, all of which may connect to a global communications network, for example, the Internet.

When used in a local area network 1556 networking environment, the computer 1502 is connected to the local area network 1556 through a wire and/or wireless communication network interface or network adapter 1538. The network adapter 1538 can facilitate wire and/or wireless communications to the local area network 1556, which may also include a wireless access point disposed thereon for communicating with the wireless functionality of the network adapter 1538.

When used in a wide area network 1554 networking environment, the computer 1502 can include a modem 1540, or is connected to a communications server on the wide area network 1554 or has other means for establishing communications over the wide area network 1554, such as by way of the Internet. The modem 1540, which can be internal or external and a wire and/or wireless device, connects to the system bus 1506 via the input device interface 1536. In a networked environment, program modules depicted relative to the computer 1502, or portions thereof, can be stored in the remote memory and/or storage device 1558. It will be appreciated that the network connections shown are exemplary and other means of establishing a communications link between the computers can be used.

The computer 1502 can be operable to communicate with wired and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASICs), PLDs, DSPs, field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, ASICs, logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

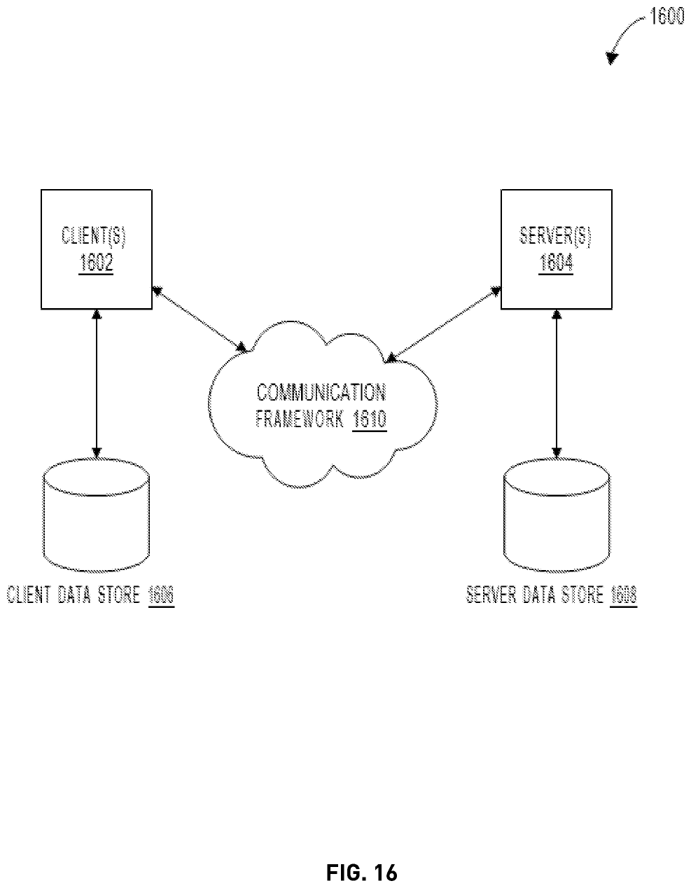

FIG. 16 is a block diagram depicting an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600, which may be consistent with systems and devices discussed herein.

As shown in FIG. 16, the communications architecture 1600 includes one or more client(s) 1602 and server(s) 1604. The server(s) 1604 may implement one or more functions and embodiments discussed herein. The client(s) 1602 and the server(s) 1604 are operatively connected to one or more respective client data store 1606 and server data store 1608 that can be employed to store information local to the respective client(s) 1602 and server(s) 1604, such as cookies and/or associated contextual information.

The client(s) 1602 and the server(s) 1604 may communicate information between each other using a communication framework 1610. The communication framework 1610 may implement any well-known communications techniques and protocols. The communication framework 1610 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1610 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1602 and the server(s) 1604. A communications network may be any one and the combination of wired and/or wireless networks including without limitation a direct interconnection, a secured custom connection, a private network (e.g., an enterprise intranet), a public network (e.g., the Internet), a PAN, a LAN, a Metropolitan Area Network (MAN), an Operating Missions as Nodes on the Internet (OMNI), a WAN, a wireless network, a cellular network, and other communications networks.

What is claimed is:

1. A method comprising:
receiving, via a short-range communication antenna of a first mobile device, first encrypted data from a first contactless card of a seller of an item for sale via a website or a mobile application;
successfully decrypting the first encrypted data to authenticate the first contactless card;
when the first contactless card has been authenticated, identifying personally identifiable information of the seller and a bank or credit account number for the seller and, responsive thereto, offering the item for sale at a purchase price via the website or the mobile application;
receiving, via a short-range communication antenna of a second mobile device, second encrypted data from a second contactless card of a buyer of the item for sale;
successfully decrypting the second encrypted data to authenticate the second contactless card;
when the second contactless card has been authenticated, identifying personally identifiable information of the buyer and a bank or credit account number for the buyer and responsive thereto, retrieving an amount of money equal to the purchase price from a bank or credit account matching the bank or credit account number for the buyer and placing the money in an escrow account;
receiving, via the short-range communication antenna of the first mobile device or the short-range communication antenna of the second mobile device, the second encrypted data from the second contactless card a second time;
successfully decrypting the second encrypted data to authenticate the second contactless card a second time;
when the second contactless card has been authenticated the second time, releasing the money in the escrow account to a bank or credit account matching the bank or credit account number for the seller.

2. The method of claim 1 further comprising:
identifying a location of the seller and identifying a location of the buyer.

3. The method of claim 2 further comprising:
using an address for the seller to identify the location of the seller; and
using an address for the buyer to identify the location of the buyer,
wherein the personally identifiable information of the seller includes the address for the seller, and wherein the personally identifiable information of the buyer includes the address for the buyer.

4. The method of claim 2 further comprising:
using a cellular or GPS location of the first mobile device to identify the location of the seller; and
using a cellular or GPS location of the second mobile device to identify the location of the buyer.

5. The method of claim 2 further comprising:
identifying a distance between the location of the buyer and the location of the seller; and
rejecting the sale from the seller to the buyer when the distance is greater than a predetermined threshold.

6. The method of claim 2 further comprising:
identifying a recommended exchange location in between the location of the buyer and the location of the seller.

7. The method of claim 6 further comprising:
identifying an exchange time for the buyer and seller to meet; and
rejecting the sale from the seller to the buyer when the location of the seller or the location of the buyer are more than a predetermined distance away from the recommended exchange location at the exchange time or within a predetermined period of time thereafter.

8. The method of claim 2 further comprising:
rejecting the sale from the seller to the buyer when the location of the seller or the location of the buyer is within a predetermined high crime area.

9. The method of claim 1 further comprising:
rejecting the sale from the seller to the buyer when the bank or credit account matching the bank or credit account number for the seller or the bank or credit account matching the bank or credit account number for the buyer has been a party to prior fraudulent activity.

10. The method of claim 1 further comprising:
causing a notification message to be sent to the first mobile device when the money in the escrow account is sent to the bank or credit account matching the bank or credit account number for the seller.

11. The method of claim 1 further comprising:
receiving the personally identifiable information of the seller or the bank or credit account number for the seller from the first contactless card; and
receiving the personally identifiable information of the buyer and the bank or credit account number for the buyer from the second contactless card.

12. The method of claim 1 further comprising:
using the first encrypted data to retrieve the personally identifiable information of the seller or the bank or credit account number for the seller from a banking or credit authorization system; and
using the second encrypted data to retrieve the personally identifiable information of the buyer or the bank or credit account number for the buyer from the banking or credit authorization system.

13. The method of claim 1 further comprising:
identifying a first customer account associated with the first contactless card to authenticate the first contactless card;
decrypting first protected data in the first encrypted data;
comparing the first protected data to first stored record data associated with the first customer account;
authenticating the first contactless card based on a match between the first protected data and the first stored record data;
identifying a second customer account associated with the second contactless card to authenticate the second contactless card;
decrypting second protected data in the second encrypted data;
comparing the second protected data to second stored record data associated with the second customer account; and
authenticating the second contactless card based on a match between the second protected data and the second stored record data.

14. A method comprising:
receiving, via a short-range communication antenna of a mobile device, first encrypted data from a first contactless card of a seller of an item for sale via a website or a mobile application;
successfully decrypting the first encrypted data to authenticate the first contactless card; and
when the first contactless card has been authenticated, identifying personally identifiable information of the seller and a bank or credit account number for the seller and, responsive thereto, offering the item for sale at a purchase price via the website or the mobile application.

15. The method of claim 14 further comprising:
responsive to authenticating second encrypted data from a second contactless card of a buyer of the item for sale, releasing money in an escrow account to a bank or credit account matching the bank or credit account number for the seller.

16. The method of claim 15 further comprising:
responsive to authenticating the second encrypted data a first time to provision an amount of money equal to the purchase price in the escrow account and a second time to secure the item for sale, releasing the money in the escrow account to the bank or credit account matching the bank or credit account number for the seller.

17. The method of claim 14 further comprising:
responsive to identifying the personally identifiable information of the seller and the bank or credit account number for the seller, creating or identifying an account for the seller on the website or the mobile application.

18. A method comprising:
receiving, via a short-range communication antenna of a first mobile device, encrypted data from a contactless card of a buyer of an item for sale at a purchase price via a website or a mobile application;
successfully decrypting the encrypted data to authenticate the contactless card; and
when the contactless card has been authenticated, identifying personally identifiable information of the buyer and a bank or credit account number for the buyer, and responsive thereto, retrieving an amount of money equal to the purchase price from a bank or credit account matching the bank or credit account number for the buyer and placing the money in an escrow account.

19. The method of claim 18 further comprising:
receiving, via the short-range communication antenna of the first mobile device or a short-range communication antenna of a second mobile device, the encrypted data from the contactless card;
successfully decrypting the encrypted data to authenticate the contactless card a second time; and
when the contactless card has been authenticated the second time, releasing the money in the escrow account to a bank or credit account matching a bank or credit account number for a seller of the item for sale.

20. The method of claim 18 further comprising:
responsive to identifying the personally identifiable information of the buyer and the bank or credit account number for the buyer, creating or identifying an account for the buyer on the website or the mobile application.
